(19) United States
(12) Patent Application Publication
(10) Pub. No.: US 2014/0112308 A1
(43) Pub. Date: Apr. 24, 2014

(54) APPARATUS AND METHOD FOR PERFORMING UPLINK SYNCHRONIZATION IN MULTI-COMPONENT CARRIER SYSTEM

(71) Applicants: Ki Bum Kwon, Seoul (KR); Jae Hyun Ahn, Seoul (KR); Myung Cheul Jung, Seoul (KR)

(72) Inventors: Ki Bum Kwon, Seoul (KR); Jae Hyun Ahn, Seoul (KR); Myung Cheul Jung, Seoul (KR)

(73) Assignee: PANTECH CO., LTD., Seoul (KR)

(21) Appl. No.: 14/123,929

(22) PCT Filed: Jun. 5, 2012
(86) PCT No.: PCT/KR2012/004441

§ 371 Date: Dec. 4, 2013

(30) Foreign Application Priority Data
Jun. 9, 2011 (KR) 10-2011-0055440

(51) Int. Cl. H04W 36/00; H04W 56/00

(52) U.S. Cl. CPC H04W 36/0072; H04W 56/001
USPC 370/331

(57) ABSTRACT

The present invention relates to an apparatus and method for performing uplink synchronization in a multi-component carrier system. A method for performing uplink synchronization according to the present invention comprises the steps of: receiving, from a base station, a message that indicates a time alignment value for adjusting an uplink time of a sub-serving cell; adjusting the uplink time on the basis of the time alignment value; and driving a validity timer, which indicates the period of validity of the time alignment value when the sub-serving cell is deactivated. According to the present invention, with respect to a sub-serving cell, which performs a random access procedure to ensure and maintain a time alignment value, the validity of the time alignment value and whether or not uplink synchronization in the sub-serving cell is made can be quickly ascertained, and efficiency of uplink data transmission can increase.

### CROSS-REFERENCE TO RELATED APPLICATIONS

This application is the National Stage Entry of International Application PCT/KR2012/004441, filed on Jun. 5, 2012, and claims priority from and the benefit of Korean Patent Application No. 10-2011-0055440, filed on Jun. 9, 2011, all of which are incorporated herein by references for all purposes as if fully set forth herein.

### BACKGROUND

1. Field

The present invention concerns wireless communication, and more specifically, is to an apparatus and method of performing uplink sync in a multi-component carrier system.

2. Discussion of the Background

A general wireless communication system, even when uplink and downlink are set to have different bandwidths from each other, primarily considers only one carrier. Also in 3GPP (3^{rd} Generation Partnership Project) LTE (Long Term Evolution), a single carrier is used for uplink and downlink, and the bandwidth of uplink is generally symmetrical with the bandwidth of downlink. In such a single carrier system, random access has been conducted using a single carrier. However, the introduction of multi-carrier systems enables random access to be done through multiple component carriers.

A multi-carrier system means a wireless communication system that may support carrier aggregation. The carrier aggregation is a technology that allows for efficient use of a bandwidth broken to pieces and this technology ties several physically non-contiguous bands in the frequency domain, thereby providing such an effect as if a logically large band is used.

A terminal undergoes a random access procedure so as to access a network. The random access procedure may be divided into a contention-based random access procedure and a non-contention-based random access procedure. The biggest difference between the contention-based random access procedure and the non-contention-based random access procedure lies in whether a random access preamble is designated to be dedicated to a single terminal. In the non-contention-based random access procedure, a terminal uses a dedicated random access preamble that is designated only to the terminal, and thus, no contention (or collision) with other terminals arises. Here, the “contention” refers to when two or more terminals attempt to do a random access procedure using the same random access preamble through the same resource. In the contention-based random access procedure, a terminal uses is an arbitrarily selected random access preamble, and thus, a contention is likely to arise.

A terminal may perform a random access procedure for the purposes of initial access, handover, request for radio resources (scheduling request), timing alignment, etc.

### SUMMARY

An object of the present invention is to provide an apparatus and method of performing uplink sync in a multi-component carrier system.

Another object of the present invention is to provide an apparatus and method of determining validity of a timing alignment value.

Still another object of the present invention is to provide an apparatus and method of operating a validity timer.

Yet still another object of the present invention is to provide an apparatus and method of controlling transmission of an uplink signal according to the operation of activating or deactivating a sub serving cell and whether to perform uplink sync.

According to an aspect of the present invention, a method of performing uplink sync by a terminal is provided. The method includes receiving from a base station a message indicating a time alignment value for adjusting a uplink time of a secondary serving cell, adjusting the uplink time based on the time alignment value, and if the secondary serving cell is deactivated, driving a validity timer indicating a validation period of the time alignment value.

In a case where the secondary serving cell is activated before the validity timer expires, the uplink transmission is performed based on the adjusted uplink time.

According to another aspect of the present invention, a method of performing uplink sync by a base station is performed. The method includes transmitting to a terminal a is message indicating a time alignment value for adjusting an uplink time of a secondary serving cell and transmitting to the terminal an activation indicator indicating activation of the secondary serving cell before a validity timer indicating a validation period of the time alignment value expires.

The uplink transmission in the secondary serving cell is performed based on an uplink time adjusted by the time alignment value.

According to still another aspect of the present invention, a terminal performing uplink sync is provided. The terminal includes a radio resource control processing unit controlling activation or deactivation of a secondary serving cell, a terminal receiving unit receiving from a base station a message indicating a time alignment value for adjusting an uplink time of the secondary serving cell, a random access processing unit adjusting the uplink time based on the time alignment value, and if the secondary serving cell is deactivated, driving a validity timer indicating a validation period of the time alignment value, and a terminal transmitting unit performing uplink transmission based on the adjusted uplink time in a case where the secondary serving cell is activated before the validity timer expires.

According to yet still another aspect of the present invention, a base station performing uplink sync is provided. The base station includes a radio resource control processing unit controlling activation or deactivation of a secondary serving cell, a base station transmitting unit to a terminal a message indicating a time alignment value for adjusting an uplink time of the secondary serving cell or an activation indicator indicating activation or deactivation of the secondary serving cell, and a base station receiving unit receiving an uplink signal based on an uplink time adjusted by the time alignment value if the secondary serving cell is activated before a validity timer indicating a validation period of the time alignment value is expires.

According to the present invention, the validity of a timing alignment value for a sub serving cell that performs a random access procedure in order to secure and maintain the timing alignment value and whether uplink sync is done in the sub serving cell may be quickly verified, together with more efficient uplink data transmission.

### BRIEF DESCRIPTION OF DRAWINGS

FIG. 1 shows a wireless communication system to which the present invention applies.

FIG. 2 shows an example of a protocol structure for supporting multiple component carriers to which the reception applies.

FIG. 3 shows an example of a frame structure for a multi-component carrier operation to which the present invention applies.

FIG. 4 shows the linkage between a downlink component carrier and an uplink component carrier in a multi-component carrier system to which the present invention applies.

FIG. 5 is a flowchart illustrating a method of performing uplink sync according to an embodiment of the present invention.

FIG. 6 is a flowchart illustrating a method of performing a random access procedure according to an embodiment of the present invention.

FIG. 7 is a flowchart illustrating a method of performing a random access procedure according to another embodiment of the present invention.

FIG. 8 is a flowchart illustrating a method of performing uplink sync according to another embodiment of the present invention.

FIG. 9 is a flowchart illustrating a method of performing uplink sync according to a still another embodiment of the present invention.

FIG. 10 is a flowchart illustrating a method of performing a random access procedure according to an embodiment of the present invention.

FIG. 11 is a flowchart illustrating a method of performing uplink sync of a terminal according to an embodiment of the present invention.

FIG. 12 is a flowchart illustrating a method of performing uplink sync of a base station according to an embodiment of the present invention.

FIG. 13 is a block diagram illustrating a base station and a terminal that perform uplink sync according to an embodiment of the present invention.

### DETAILED DESCRIPTION OF THE ILLUSTRATED EMBODIMENTS

Hereinafter, some embodiments of this disclosure will be described in detail with reference to the accompanying drawings. The same reference numeral may be used to denote the same or similar elements throughout the specification and the drawings. When determined to make the subject matter of the present invention unnecessarily unclear, the detailed description of well-known art is skipped.

Further, this disclosure is described, targeting a wireless communication network. A task that is to be achieved in the wireless communication network may be performed when a system (e.g., a base station) in charge of the wireless network controls the network and transmits data or in a terminal linked to the wireless network.

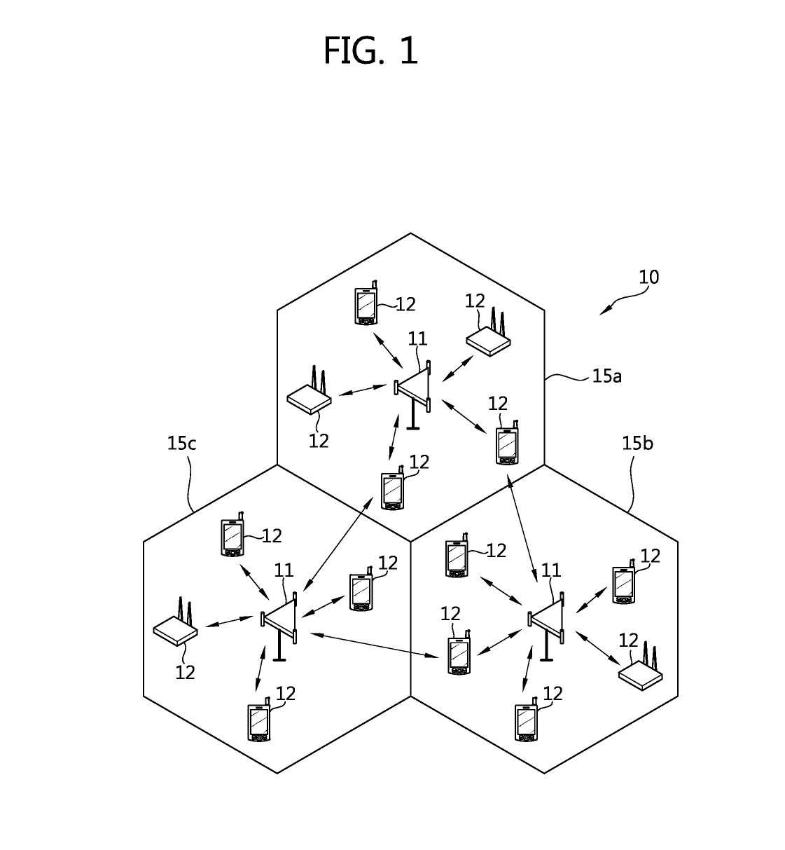

FIG. 1 shows a wireless communication system to which the present invention applies.

Referring to FIG. 1, the wireless communication system 1 has a spacious arrangement so as to provide various communication services such as voice or packet data. The wireless communication system 10 includes at least one base station (BS) 11. Each base station 11 provides a communication service in a specific cell (15a, 15b, or 15c). A cell may be separated into multiple areas (referred to as sectors).

A terminal (MS) 12 may be stationary or mobile, and may be also referred to as a UE (user equipment), an MT (mobile terminal), a UT (user terminal), an SS (subscriber station), a wireless device, a PDA (personal digital assistant), a wireless modem, a handheld device, etc. The base station 11 may also be referred to as an eNB (evolved-NodeB), a BTS (Base Transceiver System), an access point, a femto base station, a home nodeB, a relay, etc. The cell should be comprehensively construed as a partial area covered by the base station 11 and includes all of a mega cell, a macro cell, a micro cell, a pico cell, a femto cell, and other various coverage areas.

Hereinafter, the downlink refers to communication from the base station 11 to the terminal 12, and the uplink refers to communication from the terminal 12 to the base station 11. On downlink, a transmitter may be part of the base station 11, and a receiver may be part of the terminal 12. On uplink, the transmitter may be part of the terminal 12, and the receiver may be part of the base station 11. The wireless communication system is not limited as using a specific multiple access scheme. For example, the wireless communication system may adopt various multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA. Uplink transmission and downlink transmission may adopt TDD (Time Division Duplex) schemes in which different time periods from each other are used for uplink transmission and downlink transmission or FDD (Frequency Division Duplex) schemes in which different frequencies from each other are used for downlink transmission and uplink transmission.

The carrier aggregation (CA) supports a plurality of carriers and is also referred to as “spectrum aggregation” or “bandwidth aggregation.” Individual unit carriers that are tied up by the carrier aggregation are referred to as component carriers (CCs). Each component carrier is defined by a bandwidth and a central frequency. The carrier aggregation has been introduced to support increasing throughput, prevent a cost increase due to the introduction of wideband RF (Radio Frequency) elements, and ensure compatibility with existing systems. For example, if, as a granularity of carrier basis, five component carriers are allocated each having a bandwidth of 20 MHz, up to a bandwidth of 100 MHz may be supported.

The carrier aggregation may be divided into contiguous carrier aggregation that is done between contiguous component carriers in the frequency domain and non-contiguous carrier aggregation that is done between non-contiguous component carriers in the frequency domain. The number of component carriers aggregated for uplink may be set to be different from the number of component carriers aggregated for downlink. When the number of downlink component carriers is the same as the number of uplink component carriers is referred to as symmetric aggregation, and when the number of downlink component carriers is different from the number of uplink component carriers is referred to as asymmetric aggregation.

The magnitudes (i.e., bandwidths) of the component carriers may be different from each other. For example, when five component carriers are used to configure a band of 70 MHz, the configuration may be as follows: a 5 MHz component carrier (carrier #0)+a 20 MHz is component carrier (carrier #1)+a 20 MHz component carrier (carrier #2)+a 20 MHz component carrier (carrier #3)+a 5 MHz component carrier (carrier #4).

Hereinafter, the multi-component carrier system refers to a system that supports carrier aggregation. The multi-component carrier system may use contiguous carrier aggregation and/or non-contiguous carrier aggregation or symmetric carrier aggregation or asymmetric carrier aggregation.

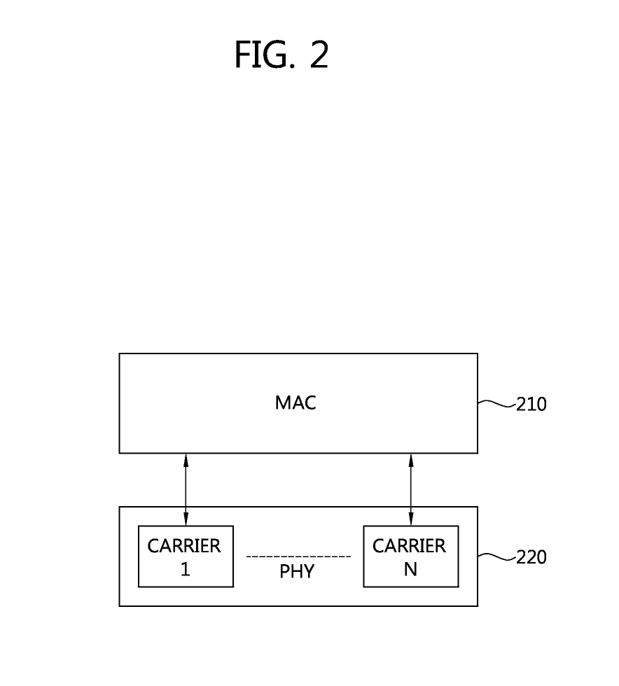

FIG. 2 shows an example of a protocol structure for supporting multiple component carriers to which the reception applies.

Referring to FIG. 2, a common MAC (Medium Access Control) entity 210 manages a physical layer 220 that uses a plurality of carriers. An MAC management message that is transmitted over a specific carrier may be applicable to another carrier. That is, the MAC management message is a message that may control other carriers including the specific carrier. The physical layer 220 may operate in TDD (Time Division Duplex) and/or FDD (Frequency Division Duplex).

There are some physical control channels that are used in the physical layer 220. The physical downlink control channel (PDCCH) provides the terminal with information regarding resource allocation of a PCH (paging channel) and a DL-SCH (downlink shared channel) and HARQ (hybrid automatic repeat request) information related to the DL-SCH. The PDCCH may carry an uplink grant that informs the terminal of resource allocation of uplink transmission. The PCFICH (physical control format indicator channel) informs the terminal of the number of OFDM symbols used for PDCCHs and is transmitted every subframe. The PHICH (physical hybrid ARQ indicator channel) is a response to uplink transmission and carries an HARQ ACK/NAK signal. The PUCCH (Physical uplink control channel) carries uplink is control information such as an HARQ ACK/NAK, a scheduling request, and a CQI for downlink transmission. The PUSCH (physical uplink shared channel) carries a UL-SCH (uplink shared channel). The PRACH (physical random access channel) carries a random access preamble.

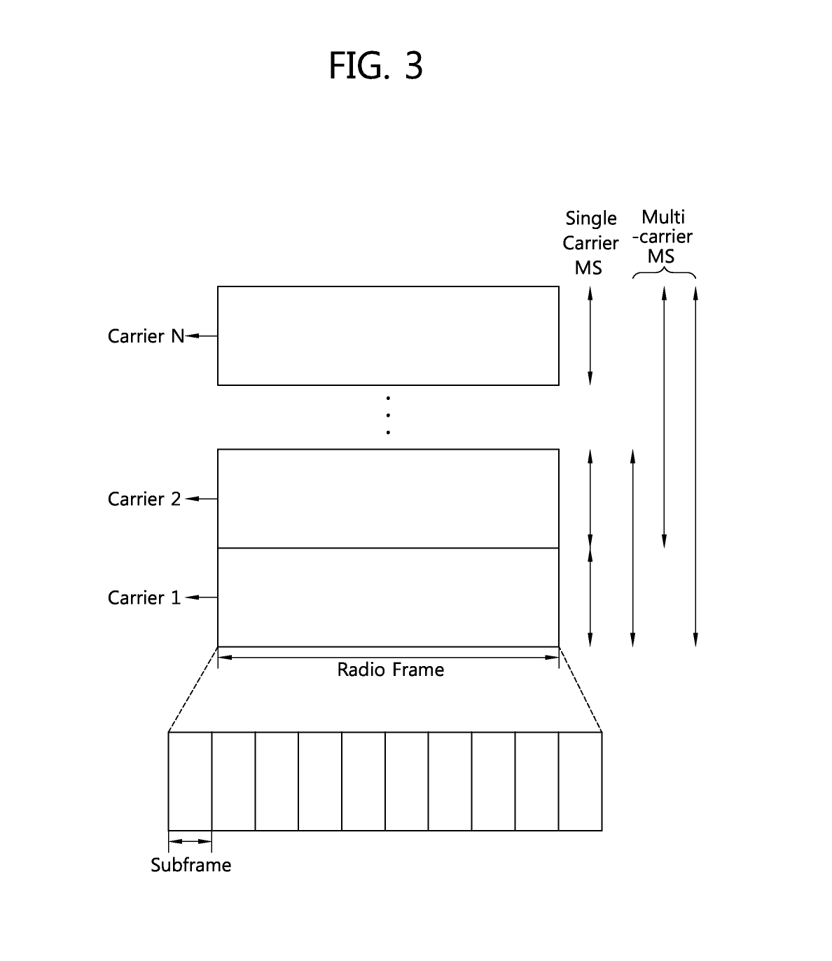

FIG. 3 shows an example of a frame structure for a multi-component carrier operation to which the present invention applies.

Referring to FIG. 3, a frame consists of 10 sub-frames. Each sub-frame includes a plurality of OFDM symbols. Each carrier may carry its own control channels (e.g., PDCCH). The multiple carriers may be contiguous to each other or not. The terminal may support one or more carriers at its capacity. Here, in order to indicate an area where control information (PDCCH) is transmitted through the downlink component carrier, the PCFICH (physical control format indicator channel) matches the first one of the plurality of OFDM symbols.

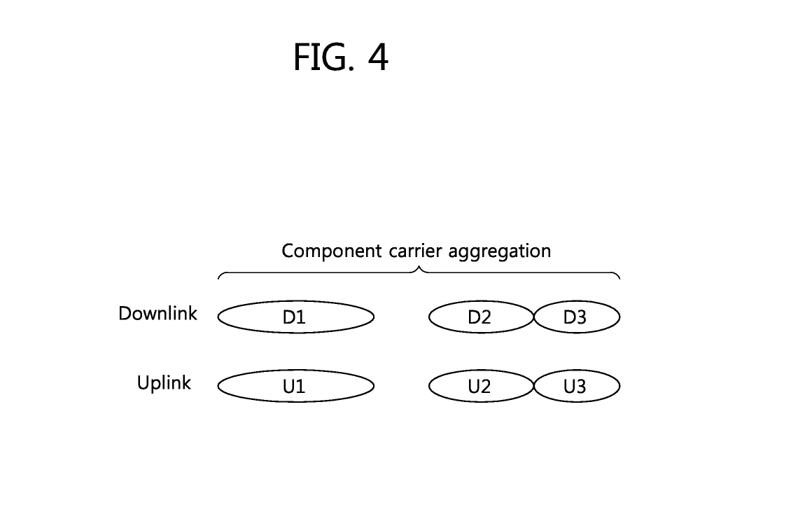

FIG. 4 is a view schematically illustrating the concept of a multi-component carrier system to which the present invention applies.

Referring to FIG. 4, on downlink, as an example, downlink component carriers D1, D2, and D3 may be aggregated, and uplink component carriers U1, U2, and U3 may be aggregated. Here, Di is the index of a downlink component carrier, and Ui is the index of an uplink component carrier (i=1, 2, and 3). Each index is not essentially consistent with the order of each component carrier or the position of the component carrier on the frequency band.

Meanwhile, at least one downlink component carrier may be set as a primary component carrier, and the other downlink component carriers may be set as secondary component carrier. Further, at least one uplink component carrier may be set as a primary component carrier, and the other uplink component carriers may be set as secondary component carriers. For example, D1 and U1 are primary component carriers and D2, U2, D3, and U3 are is secondary component carriers.

Here, the index of the primary component carrier may be set as 0, and one of the other natural numbers may be the index of a secondary component carrier. Further, the index of a downlink/uplink component carrier may be set to be the same as the index of a component carrier (or serving cell) in which the downlink/uplink component carrier is included. As another example, the component carrier index or secondary component carrier index only is configured, while there is no uplink/uplink component carrier index included in the corresponding component carrier.

In an FDD system, a downlink component carrier and an uplink component carrier may be configured to be connected in a one to one manner. For example, D1, D2, and D3, respectively, are configured to be connected to U1, U2, and U3, in a one to one manner. The terminal configures connections between downlink component carriers and uplink component carriers through system information transmitted through a logical channel BCCH or a terminal-dedicated RRC message transmitted through a DCCH. Such connections are referred to as SIB1 system information block 1) connections or SIB2 (system information block 2) connections. Each connection may be configured cell-specifically or terminal-specifically (or UE-specifically). By way of example, a primary component carrier is connection configured cell-specifically, and a secondary component carrier may be connection configured UE-specifically.

Here, the downlink component carriers and the uplink component carriers may be connected not only in a one to one manner but also in a one to n or n to one manner.

The downlink component carrier corresponding to a primary serving cell is referred to as a downlink primary component carrier (DL PCC), and the uplink component is carrier corresponding to a primary serving cell is referred to as an uplink primary component carrier (UL PCC). Further, on downlink, the component carrier corresponding to a secondary serving cell is referred to as a downlink secondary component carrier (DL SCC), and on uplink, the component carrier corresponding to a secondary serving cell is referred to as an uplink secondary component carrier (UL SCC). Only one downlink component carrier may correspond to one serving cell, and a DL CC and a UL CC both may correspond to the serving cell.

The primary serving cell means one serving cell that provides a security input and NAS mobility information under the RRC established or re-established state. Depending on the capabilities of the terminal, at least one cell, along with the primary serving cell, may be configured to form a set of serving cells, and the at least one cell is referred to as a secondary serving cell. A serving cell set configured for one terminal consists of only one primary serving cell or may consist of one primary serving cell and at least one secondary serving cell.

In the carrier system, the communication between the terminal and the base station being achieved through a DL CC or a UL CC is equivalent in concept to the communication between the terminal and the base station being achieved through a serving cell. For example, in a method of performing random access according to the present invention, the terminal transmitting a preamble using a UL CC may be considered to be equivalent in concept to transmitting a preamble using a primary serving cell or secondary serving cell. Further, the terminal receiving downlink information using a DL CC may be deemed equivalent in concept to receiving downlink information using a primary serving cell or secondary serving cell.

The primary serving cell and the secondary serving cell have the following characteristics.

First, the primary serving cell is used for transmitting a PUCCH. In contrast, the secondary serving cell cannot transmit a PUCCH but may transmit some control information in the PUCCH through a PUSCH.

Second, the primary serving cell always remains activated, whereas the secondary serving cell is a carrier that switches between activation and deactivation depending on specific conditions. The specific conditions may include receiving an activation/deactivation MAC control component message of the base station or expiration of the deactivation timer in the terminal.

Third, when the primary serving cell experiences a radio link failure (hereinafter, “RLF”), an RRC reestablishment is triggered, while when the secondary serving cell goes through an RLF, no RRC reestablishment is triggered. The radio link failure occurs when downlink capability is kept lower than a threshold for a predetermined time or more or when an RACH fails a number of times which is not less than a threshold.

Fourth, the primary serving cell may be varied by changing a security key or by a handover procedure that comes alongside the RACH procedure. However, in the case of a CR (contention resolution) message, the PDCCH indicating the CR, only, should be transmitted through the primary serving cell, and the CR information may be transmitted through the primary serving cell or secondary serving cell.

Fifth, NAS (non-access stratum) information is received through the primary serving cell.

Sixth, in the primary serving cell, a DL PCC and a UL PCC are always configured in pair.

Seventh, a primary serving cell for each terminal can be configured by a different CC.

Eighth, procedures such as reconfiguration, addition and removal of the secondary serving cell may be performed by a radio resource control (RRC) layer. In adding a new serving cell, RRC signaling may be used for transmitting system information of a dedicated secondary serving cell.

Ninth, the primary serving cell may provide both a PDCCH (for example, downlink allocation information or uplink grant information) allocated to a UE-specific search space configured to transmit control information to only a specific terminal in the area where control information is transmitted and a PDCCH (for example, system information (SI), random access response (RAR), transmit power control (TPC)) allocated to a common search space configured to transmit control information to multiple terminals that satisfy a specific condition or all the terminals in the cell. In contrast, the secondary serving cell may configure a UE-specific search space only. That is, since the terminal cannot identify the common search space through the secondary serving cell, the terminal cannot receive control information transmitted only through the common search space and data information indicated by the control information.

Among secondary serving cells, a secondary serving cell may be defined where a common search space (CSS) may be defined, and such secondary serving cell is denoted a to special secondary serving cell (SCell). The special secondary serving cell, upon cross carrier scheduling, is always set as a scheduling cell. Further, a PUCCH set for the primary serving cell may be defined for the special secondary serving cell.

The PUCCH for the special secondary serving cell may be fixed upon configuring the special serving cell or may be allocated (configured) or released by RRC is signaling (RRC reconfiguration message) when the base station reconfigures the corresponding secondary serving cell.

The PUCCH for the special secondary serving cell includes CQI (channel quality information) or ACK/NACK information of the secondary serving cells present in the corresponding sTAG, and as described above, may be configured through RRC signaling by the base station.

Further, the base station may configure one special secondary serving cell among multiple secondary serving cells or may configure no special secondary serving cell. The reason why no special secondary serving cell is configured is that there is no need for configuration of a CSS and PUCCH, such as, for example, when no contention-based random access procedure is determined to be required for any secondary serving cell or when the capacity of the PUCCH in the current primary serving cell is determined to be sufficient so that the PUCCH for an additional secondary serving cell need not be configured.

The technical spirit of the present invention regarding the characteristics of the primary serving cell and the secondary serving cell are not essentially limited to what has been described above, which is merely an example, and more examples may be included therein.

In a wireless communication environment, a propagation delay occurs while an RF signal is transmitted from a transmitter to a receiver. Accordingly, although the transmitter and the receiver both are exactly aware of the time when the RF signal is transmitted from the transmitter, the time when the signal arrives at the receiver is influenced by the distance between the transmitter and the receiver or ambient propagation environments, and in case the receiver moves on, the arrival time is changed. In case the receiver cannot be exactly aware of the time when the signal transmitted from the transmitter is received by the receiver, the receiver fails to is receive the signal, or even if succeeding, happens to receive a distorted signal, thus rendering it impossible to communicate.

Accordingly, in a wireless communication system, sync between the base station and the terminal should be first achieved on downlink/uplink, whichever, in order to receive an information signal. There are various types of sync, such as frame sync, information symbol sync, sampling period sync, etc. The sampling period sync should be most basically achieved in order to differentiate physical signals from each other.

Downlink sync is performed by the terminal based on a signal from the base station. The base station transmits a specific signal mutually promised for the terminal to easily perform downlink sync. The terminal should be exactly aware of the time when the specific signal has been transmitted from the base station. In case of downlink, one base station sends out the same sync signal to multiple terminals at the same time, the terminals each may independently obtain sync.

In case of uplink, a base station receives signals from multiple terminals. In case the distance between each terminal and the base station is different, the signals received by the base station have different transmission delay times, respectively, and in case uplink information is transmitted based on each obtained downlink sync, information from each terminal is received by the base station at different times. In such case, the base station cannot to obtain sync based on any one terminal. Accordingly, obtaining uplink sync requires a procedure different from that of downlink.

Meanwhile, obtaining uplink sync may have a different need for each multiple access scheme. For example, in case of a CDMA system, even when a base station receives uplink signals from terminals at different times, the base station may separate tie uplink signals is from each other. However, in a wireless communication system based on OFDMA or FDMA, a base station simultaneously receives uplink signals from all the terminals and demodulates the received signals at the same time. Accordingly, as uplink signals are received from multiple terminals at a more precise time, the performance of reception increases, and as a difference in reception time between the terminals increased, the reception performance may sharply decrease. Therefore, obtaining uplink sync may be inevitable.

A random access procedure may be conducted to obtain uplink sync, and during the random access procedure, the terminal obtains uplink sync by adjusting an uplink time based on a time alignment value transmitted from the base station. A predetermined time after the uplink sync has been obtained based on the time alignment value, it needs to be determined whether the obtained uplink sync is valid. For this, the terminal defines a time alignment timer (TAT) that may be configured by the base station and that, when expired, enables an uplink sync obtaining procedure to be initiated. When the time alignment timer is in operation, it is determined that the terminal and the base station stay in synchronization with each other. When the time alignment timer expires or does not operate, it is determined that the base station is not in synchronization with the base station, and the terminal does not perform uplink transmission except for transmission of a random access preamble. Specifically, the time alignment timer operates as follows.

i) In case the terminal receives a time advance command through an MAC control element from the base station, the terminal applies a time alignment value indicated by the received time advance command to uplink sync. The terminal starts or restarts the time alignment timer.

ii) In case the terminal receives a time advance command through a random is access response message from the base station, if the terminal's MAC layer didn't select the random access response message (a), the terminal applies the time alignment value indicated by the time advance command to the uplink sync and starts or restarts the time alignment timer. Or, in case the terminal receives a time advance command through a random access response message from the base station, if the terminal's MAC layer selects the random access response message and the time alignment timer is not in operation (b), the terminal applies the time alignment value indicated by the time advance command to the uplink sync and starts the time alignment timer, and if failing a contention resolution that is a subsequent random access step, it stops the time alignment timer. Or, in a case other than (a) and (b), the terminal disregards the time advance command.

iii) If the time alignment timer expires, the terminal flushes data stored in all the HARQ buffers. The terminal informs a release of PUCCH/SRS to the RRC layer. At this time, a type 0 SRS (periodic SRS) is released, and a type 1 SRS (aperiodic SRS) is not released. The terminal initializes (clears) all the configured downlink and uplink resource allocations.

In order to transmit an uplink signal except for a random access preamble, the terminal should obtain a valid time alignment value for a UL CC corresponding to a corresponding serving cell. If the valid time alignment value for the UL CC is obtained, the terminal may periodically or aperiodically transmit an uplink signal such as a sounding reference signal (SRS) on the UL CC. The SRS is a basis for the base station to update the time alignment value. The base station may identify, in real-time, whether the time alignment value obtained for the UL CC is valid or needs to be updated from the uplink signal. If the time alignment value needs to be updated, the base station may inform the updated time alignment value to the terminal through an MAC control element (CE).

Such uplink signal may be transmitted only when the UL CC is activated. In other words, when a secondary serving cell is in a deactivated state, the terminal cannot transmit an uplink signal through a UL SCC corresponding to the secondary serving cell. Accordingly, the base station or terminal cannot determine validity of the existing time alignment value. That is, being impossible to transmit an uplink signal due to deactivation of the secondary serving cell leads to uncertainty about validity of the time alignment value. Accordingly, if the deactivated secondary serving cell is activated by an activation indicator under the situation where the validity of the existing time alignment value is not confirmed for a predetermined time, the terminal needs a process for verifying whether the existing time alignment value is valid. This is why, depending on whether the time alignment value is valid, a subsequent procedure, e.g., whether an uplink signal may be transmitted, may be varied.

If the time alignment value is valid, the terminal may transmit an uplink signal according to an uplink time adjusted based on the existing time alignment value. However, unless the time alignment value is valid, the terminal should secure an updated time alignment value using a random access procedure before transmitting the uplink signal.

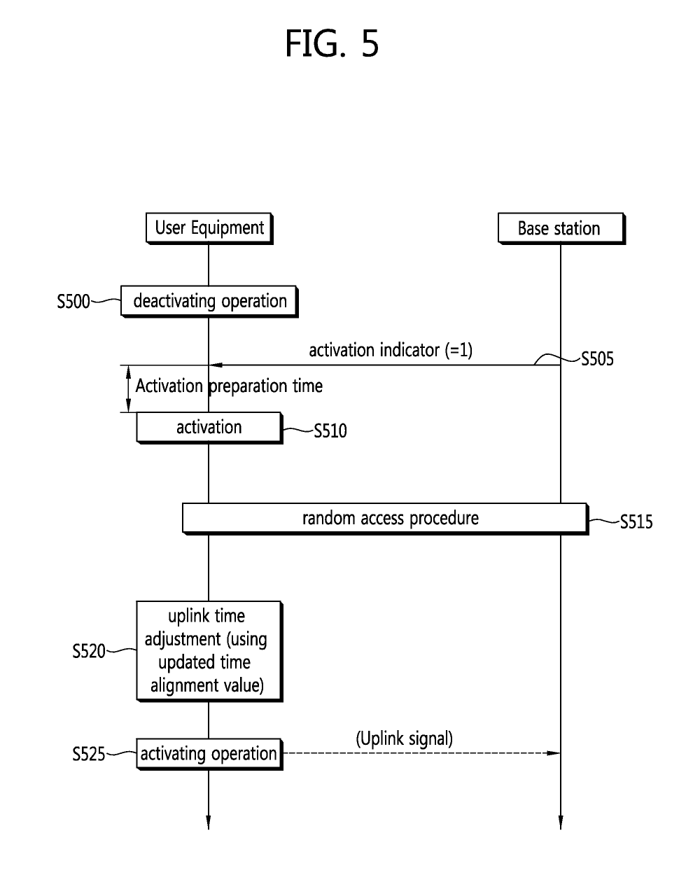

FIG. 5 is a flowchart illustrating a method of performing uplink sync according to an embodiment of the present invention.

Referring to FIG. 5, the terminal performs a deactivation operation on a deactivated secondary serving cell (S500). Here, at the time of performing the deactivation operation, the terminal is in the state where reception from the base station has been complete through an MAC message indicating the time alignment value and adjustment of an uplink time has been complete based on the previously set time alignment value. Here, the MAC message indicating the time alignment value includes, e.g., a random access response message or an MAC is control element for a time advance command.

The deactivation operation of the terminal for a deactivated secondary serving cell is as follows. i) The terminal stops the operation of the deactivation timer regarding the secondary serving cell. ii) Regarding a DL SCC corresponding to the secondary serving cell, the terminal stops monitoring a PDCCH for the control region of the secondary serving cell. This also includes the terminal stopping the PDCCH monitoring operation of the control region configured for scheduling the secondary serving cell in the entire control region of the secondary serving cell configured for cross component carrier scheduling (CCS). Further, the terminal does not “receive” information on downlink and uplink resource allocation in the secondary serving cell. Further, the terminal does not react to the downlink and uplink resource allocation in the secondary serving cell. Here, the term “react” may include transmitting ACK/NACK information that refers to success or failure of reception of information on resource allocation. The terminal does not process the downlink and uplink resource allocation for the secondary serving cell. For example, the term “process” may include both the “receive” and “react.”

iii) Regarding a UL SCC corresponding to the secondary serving cell, the terminal stops transmission of the periodic SRS and aperiodic SRS. Further, the terminal stops reporting channel quality information (CQI). The terminal stops transmission or retransmission of the PUSCH.

The terminal's activating operation for the activated secondary serving cell is to execute all the operations that are stopped in the deactivating operation. The activating operation includes an uplink activating operation and a downlink activating operation. For example, the downlink activating operation includes the terminal initiating the operation of a deactivation timer for the secondary serving cell, monitoring a PDCCH for the control region of is the secondary serving cell regarding a DL SCC corresponding to the secondary serving cell, or an operation that proceeds for downlink and uplink resource allocation for the secondary serving cell. Meanwhile, the uplink activating operation includes the terminal performing transmission of an uplink signal. For example, the terminal performs transmission of a periodic SRS and an aperiodic SRS regarding a UL SCC corresponding to the secondary serving cell or reports channel quality information. Or, the uplink activating operation includes the terminal performing transmission or retransmission of a PUSCH.

The terminal receives, from the base station, an activation indicator indicating activation of a deactivated secondary serving cell (S505). The activation indicator may be transmitted in the form of a medium access control (MAC) message. For example, the activation indicator includes an MAC subheader and an MAC control element. Here, the MAC subheader includes an LCID field corresponding to a specific MAC control element, and the LCID field includes a logical channel identifier (LCID) field that represents that the corresponding MAC control element is an MAC control element indicating activation or deactivation of a serving cell. Examples of what is indicated by the LCID field values are shown in Table 1:

TABLE 1

| LCID index | LCID value |
|---|---|
| 00000 | CCCH |
| 0001-01010 | Logical channel identifier |
| 01011-11010 | Reserved |
| 11011 | Activated/deactivated |
| 11100 | Terminal contention solving |
| | identifier |
| 11101 | Time advance command(TAC) |
| 11110 | DRX command |
| 11111 | padding |

Referring to Table 1, if the LCID value is 11011, its corresponding MAC control element is an MAC control element indicating (or for) activation or deactivation of a serving cell. The MAC control element indicating activation or deactivation of a serving cell has an 8-bit octet structure and may indicate activation or deactivation each serving cell in the form of a bitmap. The position of each bit is one-to-one mapped with the serving cell of a specific index. For example, the least significant bit (LSB) may be mapped with a serving cell of index 0, and the most significant bit (MSB) may be mapped with a serving cell of index 7. Or, the least significant bit may mean the cell index of a primary serving cell. In such case, the bit that is mapped with the primary serving cell does not have a meaning regarding activation or deactivation. If a bit is 0, this may indicate that the serving cell corresponding to the bit is deactivated, and if a bit is 1, this may indicate that a serving cell corresponding to the bit is activated. Meanwhile, the bit information of a position mapped with a secondary serving cell that is not configured in the terminal is not considered by the terminal or disregarded, or may be set as a specific value, e.g., 0, by the base station.

An activation preparation time (APT) after the activation indicator has been received, the terminal activates the deactivated secondary serving cell (S510). Here, the activation preparation time may be at least one sub-frame, for example, eight sub-frames. Accordingly, if a kth sub-frame receives the activation indicator, the terminal activates the is secondary serving cell in a (k+8)th sub-frame.

Even when the secondary serving cell is activated, the terminal cannot immediately perform an uplink activating operation such as transmission of an uplink signal (for example, an SRS) in the activated secondary serving cell. This is why, due to a shift from deactivation to activation of the secondary serving cell, the existing time alignment value happened to be not valid any longer. Accordingly, the terminal obtains a time alignment value updated by a random access procedure and may perform an uplink activating operation on the secondary serving cell according to an uplink time adjusted based on the updated time alignment value.

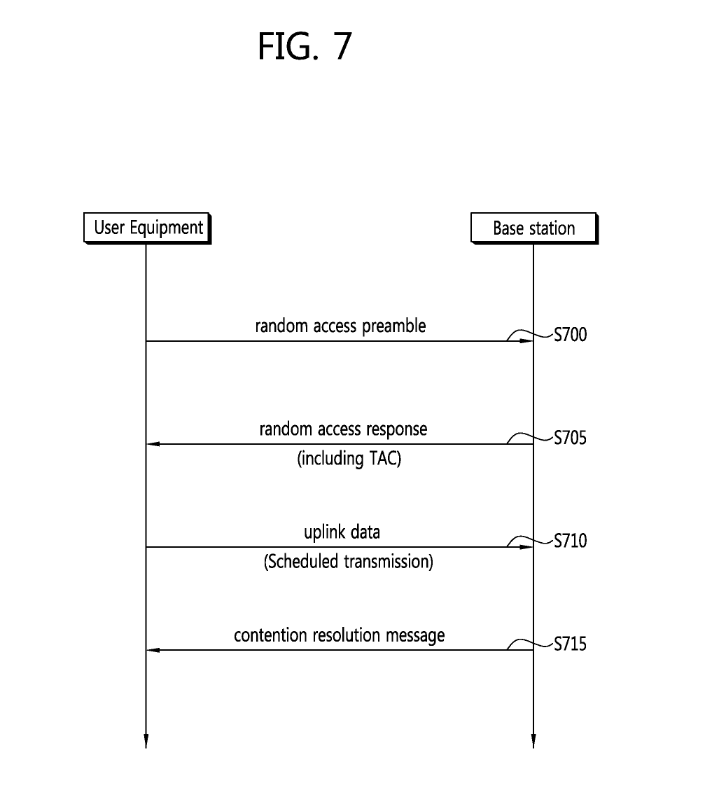

The terminal performs a random access procedure in the secondary serving cell (S515) and obtains an updated time alignment value from the random access procedure. The random access procedure may be a non-contention based one or a contention-based one. The non-contention based random access procedure may be initiated by a random access procedure performing command issued by the base station, and its detailed description will be given below with reference to FIG. 7.

According to an embodiment of the present invention, during the course when the secondary serving cell is deactivated and is back to activation, the existing time alignment value is not deemed valid any longer and is not applied to the uplink time adjustment. Accordingly, the terminal, when or after the secondary serving cell is deactivated, discards or resets the invalid existing time alignment value or after obtaining an updated time alignment value, may replace the existing time alignment value with the updated time alignment value.

As another example, the validity of a time alignment value may be defined for each time alignment group (TAG) that is a group of serving cells having the same time alignment is value (i.e., requiring the same amount of uplink time adjustment). When all of the secondary serving cells in the time alignment group are deactivated after receiving a deactivation indicator from the base station and then go back to activation, when all of the secondary serving cells in the time alignment group are deactivated due to expiration of the deactivation timer in the terminal and then go back to activation, or when all of the secondary serving cells in the time alignment group are deactivated as some of the secondary serving cells in the time alignment group receive a deactivation indicator or others have the deactivation timer in the terminal expired and later go back to activation, the existing time alignment value set to the secondary serving cells in the time alignment group may be considered to be not valid any longer.

As still another example, in case a validity timer is defined for each time alignment group, during the course when a secondary serving cell (reference or special SCell) that has secured configuration information on the random access procedure in the time alignment group is deactivated and is then back to activation, the existing time alignment value set to the secondary serving cells in the time alignment group may be considered to not be valid any longer.

The terminal adjusts an uplink time based on an updated time alignment value (S520). By way of example, the terminal calculates a time (TA) to be adjusted using a time alignment value provided from the base station and may adjust the uplink time. The time to be adjusted (TA) may be obtained in Equation 1:

TA(N_{TA}+N_{TA offset})STₛ [Equation 1]

Here, N_{TA} is the timing offset between an uplink radio frame and a downlink radio frame in a terminal and is denoted Tₛ. N_{TA} is variably controlled by a time advance is command from a base station, and N_{TAoffset} is a fixed value by a frame structure. Tₛ is a sampling period.

Meanwhile, the previous timing offset (N_{TA-old}) is adjusted to a new timing offset (N_{TA-new}) by time alignment value (Tᵢ). N_{TA-new} may be calculated in Equation 2:

N_{TA-new}=N_{TA-old}+(Tᵢ−1)s16 [Equation 2]

Referring to Equation 2, Ti is an index value and is 0, 1, 2, . . . , or 63. That is, Tᵢ may be represented by six bits and this is indicated by the time advance command field. Here, if N_{TA} is positive (+), this denotes that adjustment is made so that uplink time advances, and if N_{TA} is negative (−), this denotes that adjustment is made so that the uplink time delays. In other words, the time advance command field indicates a time alignment value that is a relative change in the uplink time relative to a previous uplink time.

Or, the time alignment value may also be used for determining a timing offset (N_{TA}) of a TAG including a secondary serving cell relative to a change in uplink time of a TAG including a primary serving cell.

As another example, the time (TA) to be adjusted may be calculated by a time alignment value regarding a secondary serving cell obtained based on a time alignment value regarding a primary serving cell.

The terminal performs an uplink activating operation in a secondary serving cell based on an adjusted uplink time (S525). For example, the terminal initiates an operation of a deactivation timer regarding a secondary serving cell, monitors a PDCCH for the control region is of the secondary serving cell regarding a DL SCC corresponding to the secondary serving cell, or proceeds with downlink and uplink resource allocation for the secondary serving cell. Or, the terminal performs transmission of an uplink signal. For example, the terminal performs transmission of a periodic SRS and an aperiodic SRS regarding a UL SCC corresponding to a secondary serving cell or reports channel quality information. Or, the terminal performs transmission or retransmission of a PUSCH.

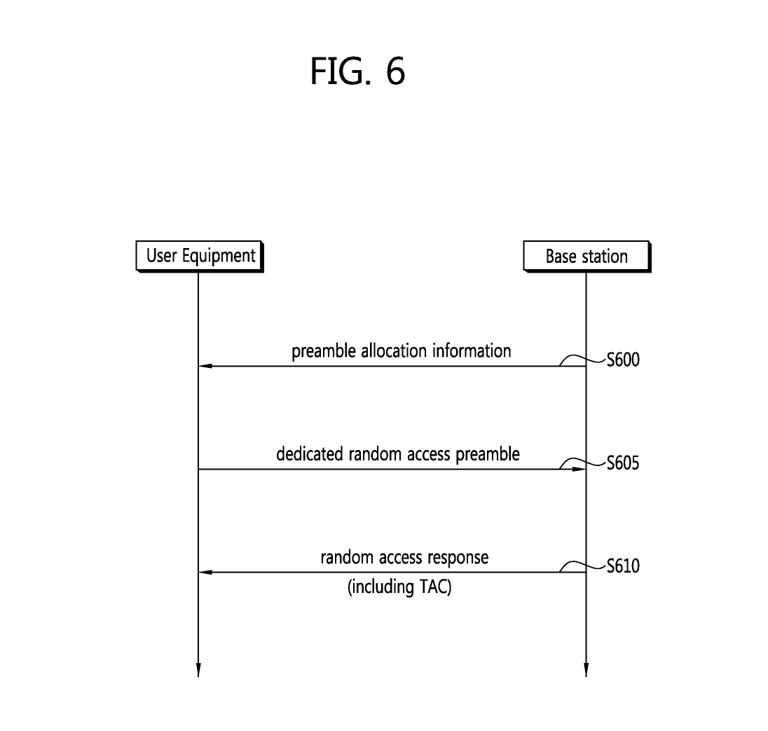

FIG. 6 is a flowchart illustrating a method of performing a random access procedure according to an embodiment of the present invention. This is a non-contention based random access procedure.

Referring to FIG. 6, the base station selects one of previously reserved dedicated random access preambles for a non-contention based random access procedure among all the available random access preambles and transmits, to the terminal, preamble allocation (PA) information including the index of the selected random access preamble and usable time/frequency resource information (S600). The terminal needs to receive a dedicated random access preamble having no possibility of collision from the base station in order for the non-contention based random access procedure.

As an example, in case a random access procedure is performed during the course of handover, the terminal may obtain a dedicated random access preamble from a handover to command message. As another example, in case a random access procedure is performed in response to the base station's request, the terminal may obtain a dedicated random access preamble from a PDCCH, i.e., through physical layer signaling. In such case, the physical layer signaling may include the fields as shown in Table 2 as downlink control information (DCI) format 1A:

TABLE 2
Carrier indicator field (CIF)-0 or 3 bits.- flag for identifying format
0/1A -1 bit (0 indicates format 0, and 1 indicates format 1A) in case
format 1A CRC is scrambled by C-RNTI, and the remaining fields are
set as below, format 1A is used for a random access procedure that is
initiated by PDCCH command. -below - localized/distributed VRB
allocation flag - 1 bit. Set as 0- allocate resource block -
(log₂(N_{RB}^{DL}(N_{RB}^{DL} + 1)/2) bits. All bits are set as 1's- preamble
index - 6 bits- PRACH mask index - 4 bits- all remaining bits of format
1A for simple scheduling allocation of one PDSCH codeword are set
as 0's.

Referring to Table 2, the preamble index is an index that indicates one preamble selected among previously reserved dedicated random access preambles for a non-contention based random access procedure, and the PRACH mask index is usable time/frequency resource information. The usable time/frequency resource information indicates different resources from each other, depending on a frequency division duplex (FDD) system and a time division duplex (TDD) system as shown in Table 3.

TABLE 3

| PRACH | | |
|---|---|---|
| mask | | |
| index | allowed PRACH (FDD) | allowed PRACH (TDD) |
| 0 | All | All |
| 1 | PRACH resource index0 | PRACH resource index0 |
| 2 | PRACH resource index1 | PRACH resource index1 |
| 3 | PRACH resource index2 | PRACH resource index2 |
| 4 | PRACH resource index3 | PRACH resource index3 |
| 5 | PRACH resource index4 | PRACH resource index4 |
| 6 | PRACH resource index5 | PRACH resource index5 |
| 7 | PRACH resource index6 | Reserved |
| 8 | PRACH resource index7 | Reserved |
| 9 | PRACH resource index8 | Reserved |
| 10 | PRACH resource index9 | Reserved |
| 11 | All even-numbered PRACH | All even-numbered PRACH |
| | opportunities in time region, | opportunities in time region, |
| | first PRACH resource index | first PRACH resource index |
| | in the sub-frame | in the sub-frame |
| 12 | All odd-numbered PRACH | All odd-numbered PRACH |
| | opportunities in time region, | opportunities in time region, |
| | first PRACH resource index | first PRACH resource index |
| | in the sub-frame | in the sub-frame |
| 13 | Reserved | First PRACH resource index |
| | | in the sub-frame |
| 14 | Reserved | Second PRACH resource index |
| | | in the sub-frame |
| 15 | Reserved | Third PRACH resource index |
| | | in the sub-frame |

The terminal transmits the allocated dedicated random access preamble to the base station through a secondary serving cell (S605). The random access preamble may proceed after the secondary serving cell is activated. In this embodiment, the non-contention based random access procedure is basically described. However, the present invention may also apply to a contention-based random access procedure according to the base station's intention.

The base station transmits a random access response message to the terminal (S610). By way of example, the random access response message includes a time advance command (TAC) field. The time advance command field indicates a relative change in uplink time with respect to a current uplink time and may be an integer multiple of a sampling time (Tₛ), for example, 16Tₛ. The time advance command field indicates an updated time alignment value regarding a secondary serving cell. The updated time alignment value may be given as a specific index.

The base station may verify which terminal has transmitted the random access preamble through which secondary serving cell based on the received random access preamble and time/frequency resources. In other words, there may be a number of terminals having the same RA-RNTI, but only one terminal uses the same random access preamble. Accordingly, the random access response message is transmitted to the terminal through a physical downlink control channel (PDSCH) indicated by the PDCCH scrambled with the terminal's RA-RNTI.

In the non-contention based random access procedure as compared with the contention-based random access procedure, a terminal identifier such as C-RNTI in the random access response message is received together, and thus, it may be determined whether the random access procedure has been conducted normally. Accordingly, in case it is determined that the random access procedure has been conducted normally, the random access procedure is is terminated. In case the preamble index in the preamble allocation information received by the terminal is ‘000000,’ the terminal randomly selects one of contention-based random access preambles, sets the PRACH mask index value as ‘0,’ and then proceeds with a contention-based procedure. Further, the preamble allocation information may be transmitted to the terminal through an upper layer message such as RRC (for example, mobility control information (MCI) in the handover command).

FIG. 7 is a flowchart illustrating a method of performing a random access procedure according to another embodiment of the present invention. This is a contention-based random access procedure. The terminal needs uplink sync for transmitting and receiving data to/from the base station. The terminal may perform a process of receiving information necessary for sync from the base station. The random access procedure may be performed not only when the terminal is newly linked to a network through handover, but also when, after linked, the state of sync or RRC shifts from RRC_IDLE to RRC_CONNECTED. That is, the random access procedure may proceed under various circumstances.

Referring to FIG. 7, the terminal arbitrarily selects one preamble sequence from a random access preamble sequence set and transmits a random access preamble according to the selected preamble sequence to the base station using the PRACH resource of a secondary serving cell (S700).

The random access preamble may proceed after the secondary serving cell is activated. Further, a random access procedure for the secondary serving cell may be initiated by a PDCCH command transmitted by the base station.

Information on the configuration of a random access preamble set may be obtained from the base station through part of system information or a handover command message. Here, the terminal may recognize an RA-RNTI (Random Access-Radio Network Temporary Identifier) considering a time of transmission and a frequency resource temporarily selected for preamble selection or RACH transmission.

The base station transmits a random access response message to the terminal in response to the random access preamble received from the terminal (S705). At this time, a channel, PDSCH, is used. The random access response message includes a time advance command for uplink sync with the terminal, uplink radio resource allocation information, a random access preamble identifier (RAPID) for identifying terminals that perform random access, information on a time slot when the terminal's random access preamble has been received, and the terminal's temporary identifier such as temporary C-RNTI. The random access preamble identifier is provided for identifying the received random access preamble.

The terminal transmits, to the base station over a PUSCH, uplink data including a random access identifier according to an uplink time adjusted based on a time alignment value indicated by the time advance command (S710). The uplink data may include an RRC connection request, a tracking area update, a scheduling request, or buffer status reporting for data to be transmitted on uplink by the terminal. The random access identifier may include a temporary C-RNTI, a C-RNTI (the state where UE includes it), or terminal identifier information (UE contention resolution identifier). As a time alignment value applies, the terminal starts or restarts its time alignment timer. If the time alignment timer is previously in operation, the time alignment timer is restarted, and if the time alignment timer is previously not in operation, the time alignment timer is started.

Since in steps S700 and S710 transmission of random access preambles from several terminals may collide, the base station transmits, to the terminal, a contention resolution is message notifying that random access is successfully terminated (S715). The contention resolution message may include a random access identifier. In the non-contention based random access procedure, a contention occurs due to the fact that the number of available random access preambles is limited. Since unique random access preambles cannot be assigned to all of the terminals in a cell, each terminal arbitrarily selects and transmits one random access preamble from a random access preamble set. Accordingly, two or more terminals may select and transmit the same random access preamble through the same PRACH resource.

At this time, the whole uplink data transmission fails, or according to the positions or transmit power of the terminals, the base station successfully receives uplink data only from a specific terminal. In case the base station successfully receives uplink data, the base station transmits a contention resolution message using the random access identifier included in the uplink data. When receiving its random access identifier, the terminal may be aware that contention resolution is successful. To let a terminal able to be aware of whether contention succeeds or fails in a contention-based random access procedure is referred to as contention resolution.

When receiving the contention resolution message, the terminal identifies whether the contention resolution message is for its own. If it is identified that the contention resolution message is for its own, the terminal sends an ACK to the base station, and if the contention resolution message is for other terminal, no response data is sent. Of course, even in case downlink assignment is missed out or decoding a message fails, no response data is sent. Further, the contention resolution message may include a C-RNTI or terminal identifier information.

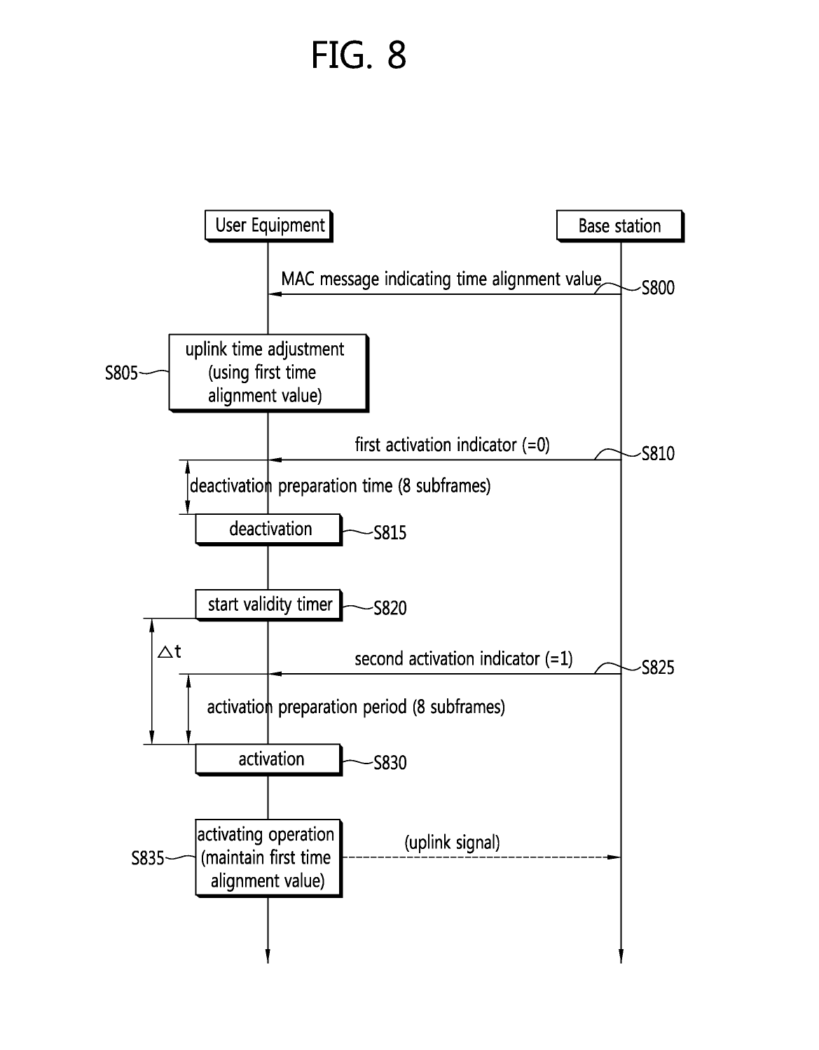

FIG. 8 is a flowchart illustrating a method of performing uplink sync according to is another embodiment of the present invention.

Referring to FIG. 8, the base station configures a first time alignment value for adjusting an uplink time of a secondary serving cell and sends an MAC message indicating the configured first time alignment value to the terminal (S800). Here, the MAC message indicating the configured first time alignment value includes a random access response message or an MAC control element for a time advance command. In case the MAC message indicating the configured first time alignment value is an MAC control element for a time advance command, an LCID field of an MAC subheader corresponding thereto is ‘11101’ according to Table 1. The MAC subheader is included in an MAC PDU together with the MAC control element for a time advance command.

The terminal adjusts an uplink time in a secondary serving cell based on the configured first time alignment value (S805). The adjustment of the uplink time may be made, for example, based on Equation 1 or Equation 2.

The terminal receives a first activation indicator indicating deactivation for an activated secondary serving cell (S810). In case the first activation indicator is received in an nth sub-frame, a deactivation preparation time (DPT), e.g., eight sub-frames, after the nth sub-frame, the terminal starts a deactivating operation for a secondary serving cell (S815).

An uplink signal used to trace uplink time sync from the secondary serving cell is deactivated until the secondary serving cell is activated is not transmitted. While the uplink signal is not transmitted, uplink time sync may be broken. This means that the first time alignment value is invalid. Nonetheless, if the terminal performs uplink transmission according to the uplink time to which the first time alignment value is applied, the base station cannot normally recognize the uplink transmission. On the contrary, if the uplink channel is stable so is that even when no uplink signal is transmitted, the uplink time sync is well maintained, the first time alignment value is still valid, and the terminal and the base station need not update the first time alignment value to a new one so as to adjust the uplink time. Accordingly, the terminal needs to determine whether the preconfigured first time alignment value is valid. For this purpose, the terminal uses a time alignment (TA) validity timer (or simply “validity timer”) regarding a secondary serving cell.

If the secondary serving cell is deactivated, the terminal drives a validity timer for the secondary serving cell (S820). At this time, the time when the validity timer is driven may be when a deactivation indicator is received from the base station, when the deactivation timer being driven by the terminal after activation expires, or when the terminal actually starts a deactivating operation. The validity timer indicates a valid period of a time alignment value. If the validity timer expires, this denotes that the time alignment value is not valid any longer, and being before the validity timer expires may denote that the time alignment value is still valid. The validity timer is driven by deactivation of a secondary serving cell and if expiration time Δt passes, it expires. Meanwhile, if the secondary serving cell is activated while the validity timer is running, the validity timer may stop.

As an example, the validity timer may be separately defined for each secondary serving cell. For example, the same expiration time Δt of a validity timer may be determined for all of the secondary serving cells configured for the terminal, or different expiration times from each other may be determined for all of the secondary serving cells, respectively.

As another example, a validity timer may be defined for each time alignment group (TAG) that is a set of serving cells having the same time alignment value (i.e., requiring the same extent of uplink time adjustment). In such case, all of the secondary serving cells in is the time alignment group are influenced by the operation of one validity timer. For example, the same validity timer may apply to all of the secondary serving cells in the time alignment group or a validity timer may apply to only the secondary serving cells (reference or special SCell) that have secured configuration information on a random access channel in the time alignment group. In such case, based on the time when all of the secondary serving cells in the time alignment group receive a deactivation indicator from the base station, the time when the deactivation timer in the terminal expires with respect to all of the secondary serving cells in the time alignment group, when some of the secondary serving cells in the time alignment group receive a deactivation indicator or others have the deactivation timer in the terminal expired so that all of the secondary serving cells in the time alignment group are deactivated, or when in all of the above cases, all of the secondary serving cells in the time alignment group start a deactivating operation, the validity timer may be driven.

As still another example, in case a validity timer is defined for each time alignment group, the validity timer may be driven based on the time when a secondary serving cell (reference or special SCell) that has secured configuration information on a random access channel in the time alignment group, when the deactivation timer in the terminal expires, or when a deactivating operation is initiated.

The validity timer configuration information including information on the time Δt when the validity timer expires may be transmitted to the terminal through upper layer signaling, for example, an RRC message. For example, the validity timer configuration information may be included in an RRC connection reconfiguration message for configuring a secondary serving cell for the terminal and may be transmitted. Or, the validity timer configuration information may be transmitted to the terminal, included in an RRC message including time alignment group is configuration information used for configuring a time alignment group in the terminal.

The base station transmits a second activation indicator (=1) indicating activation of a secondary serving cell to the terminal (S825).

By way of example, if the terminal receives the second activation indicator (=1) before the validity timer expires (kth sub-frame), or the secondary serving cell is activated ((k+8)th sub-frame), or an uplink activating operation downlink activating operation for the secondary serving cell is executed, the terminal determines that the first time alignment value is valid. If the first time alignment value is valid, the terminal performs an uplink activating operation related to transmission of an uplink signal according to the uplink time based on the first time alignment value. The transmission of the uplink signal includes transmission of an SRS or reporting channel state information.

If the validity timer expires before the terminal receives the second activation indicator, the terminal discards or resets the invalid first time alignment value, or after obtaining a new second time alignment value through the downlink secondary serving cell activated by the second activation indicator or a primary serving cell, replaces the existing first time alignment value with the second time alignment value. The second time alignment value may be obtained by a random access procedure.

As another example, in case a validity timer is defined for each time alignment group, if the terminal, before the validity timer expires, receives an activation indicator (=1) (kth sub-frame) for at least one secondary serving cell in the time alignment group, if the secondary serving cell is activated ((k+8)th sub-frame), or if an uplink and/or downlink activating operation is executed for the secondary serving cell, the terminal determines that the first time alignment value is valid for all of the secondary serving cells in the time alignment group.

As still another example, in case a validity timer is defined for each time alignment group, if the terminal receives an activation indicator (=1) for a secondary serving cell (reference or special SCell) that has secured configuration information on a random access channel in the time alignment group before the validity timer expires (a kth sub-frame) or if the secondary serving cell is activated (a (k+8)th sub-frame) or if an uplink and/or downlink activating operation on the secondary serving cell is executed, the terminal determines that the first time alignment values for all of the secondary serving cells in the time alignment group are valid.

If the activation preparation time (APT) passes, the terminal activates the deactivated secondary serving cell (S830), and in case the first time alignment value is valid, performs an uplink and/or downlink activating operation (S835). For example, the terminal initiates an operation of a deactivation timer for a secondary serving cell, monitors a PDCCH for the control region of a secondary serving cell regarding a DL SCC corresponding to the secondary serving cell, or proceeds with downlink and uplink resource allocation for the secondary serving cell. Or, the terminal transmits an uplink signal. For example, the terminal performs transmission of a periodic SRS or aperiodic SRS regarding a UL SCC corresponding to the secondary serving cell or reports channel quality information. Or, the terminal performs transmission or retransmission of a PUSCH.

Meanwhile, if the time alignment timer expires while the steps shown in FIG. 8 are performed, the terminal and the base station stop performing the steps of FIG. 8 and flush the data stored in all the HARQ buffers. The terminal informs the release of PUCCH/SRS to the RRC layer. At this time, the type-0 SRS (periodic SRS) is released, and the type-1 SRS (aperiodic SRS) is not released. The terminal initializes all configured downlink and uplink is resource allocation.

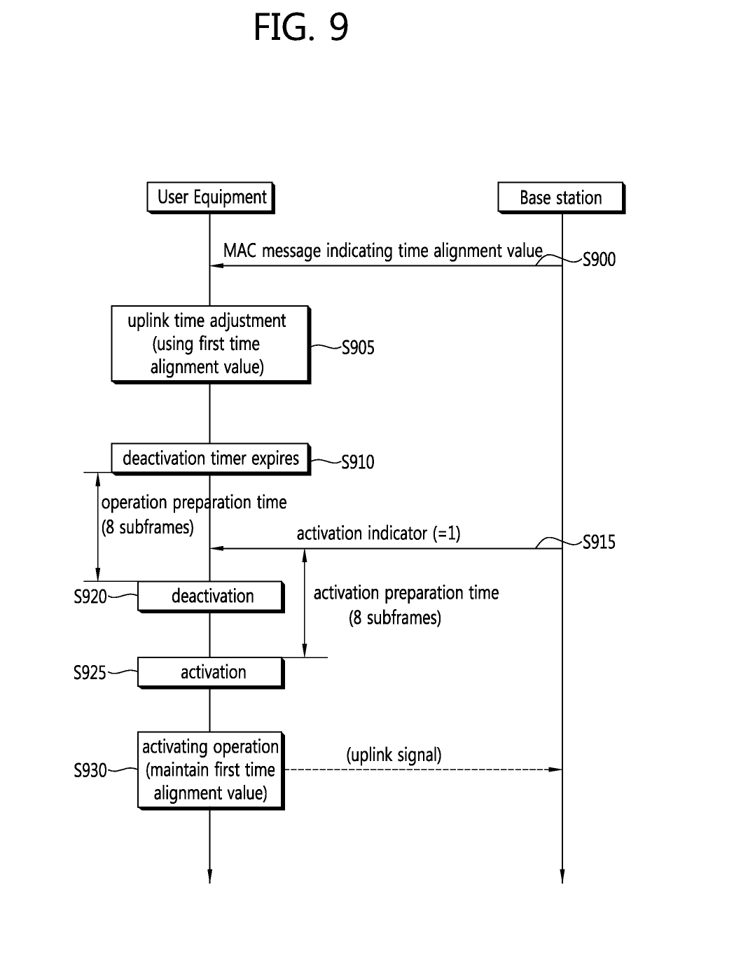

FIG. 9 is a flowchart illustrating a method of performing uplink sync according to a still another embodiment of the present invention.

Referring to FIG. 9, the base station configures a first time alignment value for adjusting an uplink time of a secondary serving cell configured in the terminal and transmits an MAC message indicating the configured first time alignment value to the terminal (S900). Here, the MAC message indicating the configured first time alignment value includes a random access response message or an MAC control element for a time advance command. In case the MAC message indicating the configured first time alignment value is an MAC control element for a time advance command, the LCID field of an MAC subheader corresponding thereto is ‘11101’ according to Table 1. The MAC subheader, together with the MAC control element for an time advance command, is included in the MAC PDU.

The terminal adjusts an uplink time in a secondary serving cell based on the configured first time alignment value (S905). The adjustment of the uplink time may be made based on, e.g., Equation 1 or 2.

The terminal continues to check a deactivation timer for a secondary serving cell. If the deactivation timer expires (S910), the terminal deactivates the secondary serving cell after an activation preparation time, e.g., eight sub-frames, from an nth sub-frame where the deactivation timer expires (S920). However, if the terminal has received an activation indicator (=1) indicating activation of a secondary serving cell from the base station (S915), the terminal determines that the first time alignment value is valid. Accordingly, the terminal, without performing step S920, activates a secondary serving cell when the activation preparation time expires (for example, after eight sub-frames) (S925), and then performs a downlink activating is operation and performs an uplink activating operation related to transmission of a signal through uplink according to the first time alignment value-based uplink time (S930). As an example of the downlink activating operation, the terminal initiates the operation of a deactivation timer regarding a secondary serving cell, monitors a PDCCH for the control region of a secondary serving cell regarding a DL SCC corresponding to the secondary serving cell, or proceeds with downlink and uplink resource allocation for a secondary serving cell. As an example of an uplink activating operation, the terminal performs transmission of an uplink signal. Specifically, the terminal performs transmission of a periodic SRS or aperiodic SRS regarding a UL SCC corresponding to a secondary serving cell or reports periodic or aperiodic channel quality information. Or, the terminal performs transmission or retransmission of a PUSCH.

If the activation preparation time expires without receiving an activation indicator indicating activation of a secondary serving cell, the terminal discards or resets the invalid first time alignment value, or after obtaining a new second time alignment value, replaces the existing first time alignment value with the second time alignment value. The second time alignment value may be obtained by a random access procedure after a secondary serving cell is activated.

Meanwhile, if the time alignment timer expires while the steps shown in FIG. 9 are performed, the terminal and the base station stop performing the steps of FIG. 9 and flush the data stored in all the HARQ buffers. The terminal informs release of the PUCCH/SRS to the RRC layer. At this time, the type-0 SRS (periodic SRS) is released, and the type-1 SRS (aperiodic SRS) is not released. The terminal initializes all configured downlink and uplink resource allocation.

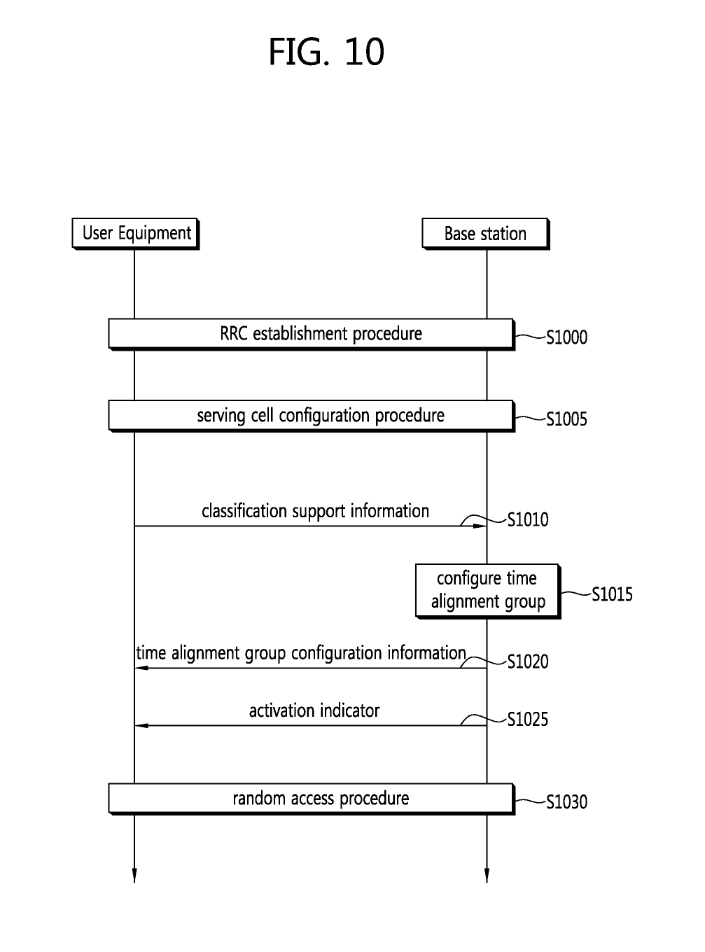

The procedures described above in connection with FIGS. 5, 8, and 9 assume that specific serving cells are configured in the terminal and that each serving cell stays activated or deactivated. It is also assumed that each serving cell may be classified on a per-time alignment group basis. Prerequisite procedures are required in order to meet such assumptions, and these are described below with reference to FIG. 10.

FIG. 10 is a flowchart illustrating a method of performing a random access procedure according to an embodiment of the present invention.

Referring to FIG. 10, the terminal selects a cell for RRC connection before component carrier aggregation and performs an RRC connection establishment procedure to the base station through the selected cell (S1000). This may be done under the assumption that terminal that are in a RRC (Radio Resource Control) idle mode, cannot aggregate component carriers while only terminals that are in an RRC connected mode may perform component carrier aggregation. The RRC connection establishment procedure is done when the terminal transmits an RRC connection request message to the base station, the base station transmits an RRC connection setup to the terminal, and the terminal transmits an RRC connection establishment complete message to the base station. The RRC connection establishment procedure includes configuring SRB1.

Meanwhile, a cell for RRC connection is selected based on the following selection requirements.

i) A most suitable cell, on which the terminal is to attempt RRC connection, may be selected based on information measured by the terminal. As the measurement information, the terminal considers both an RSRQ defined as a ratio of an RSRP value (denominator) for a specific cell relative of the whole received power (numerator) and an RSRP that measures received power based on a received CRS (cell-specific reference signal) of the specific cell. Accordingly, the terminal secures both RSRP and RSRQ values for each distinguishable cell, and based on this, selects a proper cell. For example, a cell whose RSRP and RSRQ values each has a value more than 0 dB and which has the most RSRP value may be selected, a cell having the most RSRQ value may be selected, or a proper cell may be selected based on an average value considering a weight (for example, 7:3) set for each of the RSRP and RSRQ values.

ii) RRC connection may be attempted using information on a service provider (PLMN) configured fixedly in the system which is stored in the terminal's internal memory, downlink center frequency information, or cell differentiation information (for example, PCI (Physical cell IDI)). The stored information may be configured of information on multiple service providers and cells, and a priority or priority weight may be set for each information.

iii) The terminal receives system information that has been transmitted from the base station through a broadcasting channel and may attempt a RRC connection by verifying information in the received system information. For example, the terminal should verify whether a cell is a specific cell requiring a membership for cell connection (for example, CSG (closed subscribe group), non-allowed home base station, etc.). Accordingly, the terminal receives system information transmitted from each base station and identifies CSG ID information that represents whether it is a CSG. If it is identified as a CSG, whether it is an accessible CSG is identified. To identify the accessibility, the terminal may use its membership information and unique information of the CSG cell (for example, (E)CGI ((evolved) cell global ID) or PCI information) included in the system information). In case it is identified as an inaccessible base station through the verifying procedure, no RRC connection is attempted.

iv) An RRC may be attempted through valid component carriers stored in the terminal's internal memory (for example, component carriers configurable in the frequency band is that may be supported by the terminal over an implementation).

Among the above four requirements, (ii) and (iv) are selectively applied, but (i) and (iii) should be mandatorily applied.

In order to attempt an RRC connection through a cell selected for the RRC connection, the terminal should identify an uplink band through which an RRC connection request message is to be sent. Accordingly, the terminal receives system information through a broadcasting channel transmitted through downlink of the selected cell. SIB2 (system information block 2) includes center frequency information and bandwidth information on a band that is to be used for uplink. Accordingly, the terminal attempts an RRC connection through a downlink of the selected cell and an uplink band that is connection established with the downlink through information in the SIB2. At this time, the terminal may deliver an RRC connection request message to the base station as uplink data in the random access procedure. In case the RRC connection procedure succeeds, the RRC connection established cell may be called a primary serving cell, and the primary serving cell consists of a DL PCC and a UL PCC.

The base station, in case more radio resources need to be allocated to the terminal according to the terminal's request, or a network's request, or its own determination, performs an RRC connection reconfiguring procedure to configure one or more additional secondary serving cells (SCell) in the terminal (S1005). The RRC connection reconfiguring procedure is performed by the base station transmitting an RRC connection reconfiguration message to the terminal and the terminal transmitting an RRC connection reconfiguration complete message to the base station.

The terminal transmits classifying assistant information to the base station (S1010). The classifying assistant information provides information or a standard that is is required to classify at least one serving cell configured in the terminal into a time alignment group. For example, the classifying assistant information may include at least one of the terminal's geographical location information, the terminal's neighbor cell measurement information, network deployment information, and serving cell configuration information. The terminal's geographical location information indicates a location that may be represented with the terminal's latitude, longitude, and height. The terminal's neighbor cell measurement information includes received reference signal received power (RSRP) transmitted from a neighbor cell or reference signal received quality (RSRQ) of a reference signal. The network deployment information indicates the deployment of base stations, frequency selective repeaters (FSRs) or remote radio heads (RRHs). The serving cell configuration information is information regarding a serving cell configured in the terminal. Step S1010 represents that the terminal transmits the classifying assistant information to the base station. However, the base station may be aware of the classifying assistant information in a separate way or may already retain the classifying assistant information. In such case, according to an embodiment of the present invention, random access may be performed with step S1010 omitted.

The base station configures a time alignment group by classifying serving cells (S1015). The serving cells may be classified or configured into each time alignment group according to classifying assistant information. A time alignment group is a group including at least one serving cell, and the same time alignment value applies to each serving cell in the time alignment group. For example, if a first serving cell and a second serving cell belong to the same time alignment group TAG1, the first and second serving cells are applied with the same time alignment value TA₁. In contrast, if the first and second serving cells belong to different time alignment groups TAG1 and TAG2, respectively, the first and second serving cells both are is applied with different time alignment values TA₁ and TA₂, respectively. A time alignment group may include a primary serving cell, may include at least one secondary serving cell, or may include a primary serving cell and at least one secondary serving cell.

The base station transmits time alignment group configuration information to the terminal (S1020). At least one serving cell configured in the terminal is classified into a time alignment group. That is, the time alignment group configuration information describes the state in which the time alignment group is configured. As an example, the time alignment group configuration information may include a time alignment group count field, an index field for each time alignment group, and an index field of a serving cell included in each time alignment group, and these fields describe the state in which the time alignment group is configured.

As another example, the time alignment group configuration information may further include information on a representative serving cell in each time alignment group. The representative serving cell is a serving cell that may perform a random access procedure for maintaining and configuring uplink sync in each time alignment group. The representative serving cell may also be called a special serving cell (SCell) or reference serving cell (SCell). Unlike the above embodiment, in case the time alignment group configuration information does not include a representative serving cell, the terminal may select a representative serving cell in each time alignment group on its own.

The base station transmits, to the terminal, an activation indicator for, as necessary, activating or deactivating a specific serving cell among the serving cells configured in the terminal (S1025). The terminal performs an activation or deactivation operation on each serving cell based on the activation indicator.

The terminal performs a random access procedure on the base station (S1030). The terminal performs a random access procedure on a representative serving cell based on time alignment group configuration information. Here, the random access procedure on a secondary serving cell may be initiated in response to the base station's command for performing a random access procedure. At this time, the random access procedure may proceed only when the representative serving cell is activated. In other words, a random access procedure on an activated secondary serving cell may be started by a PDCCH command transmitted by the base station. At this time, the PDCCH command is transmitted, allocated in a control information region of a secondary serving cell which is to perform the random access procedure. Further, an indicator indicating a secondary serving cell may also be included. Here, the random access procedure is performed on a non-contention basis, but depending on the base station's intention, may also be performed on a contention basis.

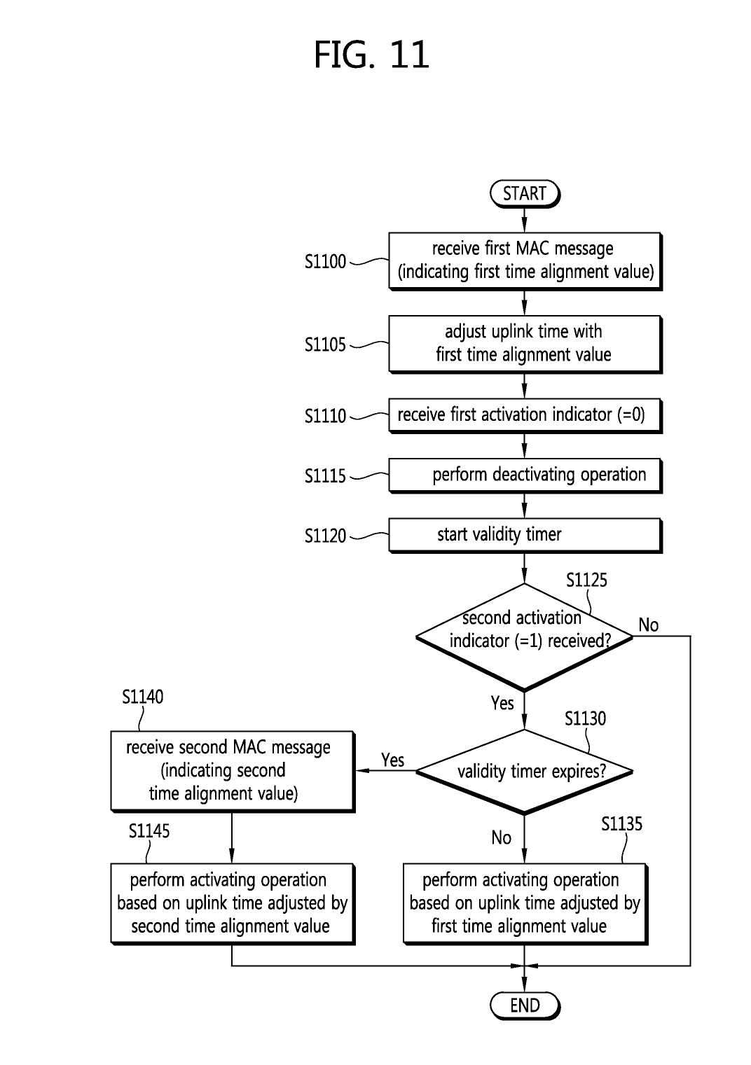

FIG. 11 is a flowchart illustrating a method of performing uplink sync of a terminal according to an embodiment of the present invention.

Referring to FIG. 11, the terminal receives, from a base station, a first MAC message indicating a first time alignment value for a secondary serving cell (S1100). The first MAC message includes, for example, an MAC control element for a time advance command or a random access response message. In case the first MAC message is an MAC control element to for a time advance command, an LCID field of an MAC subheader corresponding thereto is ‘11101’ according to Table 1. The MAC subheader, together with the MAC control element, is included in the MAC message and may be received from the base station.

The terminal adjusts a uplink time for a secondary serving cell based on the first time alignment value (S1105). The adjustment of the uplink time may be made based on, e.g., is Equation 1 or 2.

The terminal receives a first activation indicator (=0) indicating deactivation for an activated secondary serving cell from the base station (S1110). In case the first activation indicator is received at an nth sub-frame, a deactivation preparation time after the nth sub-frame, for example, eight sub-frames after the nth sub-frame, the terminal deactivates a secondary serving cell (S1115).

If a secondary serving cell is deactivated, the terminal drives a validity timer for the secondary serving cell (S1120). The operation may be performed after receiving, from the base station, a first activation indicator (=0) indicating deactivation for an activated secondary serving cell (S1110).

The terminal determines whether to receive, from the base station, a second activation indicator (=1) indicating activation of a secondary serving cell (S1125). When the terminal receives the second activation indicator (=1), the terminal checks if the validity timer has expired (S1130). If the validity timer has not expired yet, the first time alignment value is valid. Accordingly, the terminal performs an uplink activating operation, a downlink activating operation, or both an uplink activating operation and a downlink activating operation based on the uplink time adjusted by the first time alignment value (S1135). For example, the terminal initiates the operation of a deactivation timer regarding a secondary serving cell, monitors a PDCCH on the control region of a secondary serving cell regarding a DL SCC corresponding to the secondary serving cell, or proceeds with dl and uplink resource allocation for a secondary serving cell. Or, the terminal performs transmission of an uplink signal. For example, the terminal performs transmission of a periodic SRS and aperiodic SRS regarding a UL SCC corresponding to a secondary serving cell or reports channel quality information. Or, the is terminal performs transmission or retransmission of a PUSCH.

If it is determined in step S1130 that the validity timer has already expired, the first time alignment value is not valid any longer. Accordingly, the terminal performs only the downlink activating operation but does not perform an uplink activating operation related to transmission of a signal through uplink. The terminal discards or resets the first time alignment value and receives a second MAC message indicating a new second time alignment value for performing uplink sync again (S1140). The second MAC message may be received through a downlink of an activated secondary serving cell or a primary serving cell. The second MAC message may be obtained by a random access procedure. In particular, this may be initiated in response to a PDCCH command by the base station as shown in Table 2. The second MAC message includes, e.g., a random access response message or an MAC control element for a time advance command. In case the second MAC message is an MAC control element for a time advance command, an LCID field of an MAC subheader corresponding thereto is ‘11101’ according to Table 1. The MAC subheader, alongside the MAC control element, is included in the MAC message and may be received from the base station.

The terminal performs an uplink activating operation based on a uplink time adjusted by the second time alignment value (S1145).

Meanwhile, if a time alignment timer expires while the steps shown in FIG. 11 are performed, the terminal and the base station stop the steps of FIG. 11 and flush the data stored in all the HARQ buffers. The terminal informs release of a PUCCH/SRS to the RRC layer. At this time, the type-0 SRS (periodic SRS) is released, and the type-1 SRS (aperiodic SRS) is not released. The terminal initializes all configured downlink and uplink resource allocation.

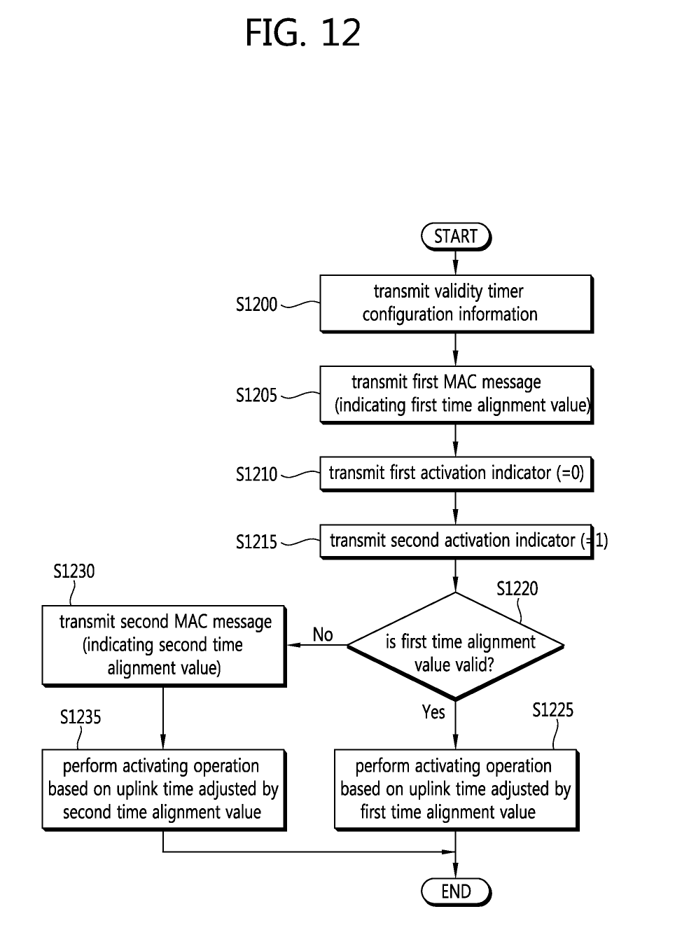

FIG. 12 is a flowchart illustrating a method of performing uplink sync of a base is station according to an embodiment of the present invention.

Referring to FIG. 12, the base station transmits validity timer configuration information on a secondary serving cell to the terminal (S1200). The validity timer configuration information may be signaling from an upper layer, for example, an RRC message. By way of example, the validity timer configuration information may be transmitted, included in an RRC connection reconfiguration message for configuring a secondary serving cell for the terminal. As another example, the validity timer configuration information may be transmitted to the terminal, included in an RRC message including time alignment group configuration information used for configuring a time alignment group in the terminal. The validity timer configuration information may define a time alignment value for each time alignment group that is a set of serving cells having the same time alignment value (that is, requiring the same extent of uplink time adjustment). In such case, all of the secondary serving cells in the time alignment group are influenced by the operation of one validity timer. For example, the same validity timer may apply to all of the secondary serving cells in the time alignment group or the validity timer may apply to only the secondary serving cell that has secured configuration information on a random access channel in the time alignment group.

The base station transmits, to the terminal, a first MAC message indicating a first time alignment value for a secondary serving cell (S1205). The first MAC message includes, e.g., a random access response message or an MAC control element for a time advance command. If the first MAC message is an MAC control element for a time advance command, an LCID field of an MAC subheader corresponding thereto is ‘11101’ according to Table 1. The MAC subheader, together with the MAC control element, is included in an MAC message and may be received from the base station.

The base station transmits, to the terminal, a first activation indicator (=0) indicating deactivation for a activated secondary serving cell (S1210). In case the first activation indicator is received at an nth sub-frame, a deactivation preparation time after the nth sub-frame, for example, eight sub-frames after the nth sub-frame, the secondary serving cell is deactivated. Due to deactivation of the secondary serving cell, the validity timer for the secondary serving cell is driven in the terminal.

The base station transmits a second activation indicator (=1) to the terminal (S1215). The base station determines validity of the first time alignment value depending on whether the terminal receives the second activation indicator before the validity timer expires or after the validity timer expires (S1220).

If the terminal receives the second activation indicator before the validity timer expires, the first time alignment value is valid. Accordingly, the base station performs an uplink and/or downlink activating operation based on a uplink time adjusted by the first time alignment value (S1225). For example, the base station transmits, to the terminal, a PDCCH for the control region of a secondary serving cell regarding a DL SCC corresponding to the secondary serving cell or proceeds with downlink and uplink resource allocation for a secondary serving cell. Or, the base station receives an uplink signal from the terminal. For example, the base station receives a periodic SRS and an aperiodic SRS regarding a UL SCC corresponding to a secondary serving cell or receives a report regarding channel quality information. Or, the base station receives a PUSCH transmitted or retransmitted from the terminal.

If it is determined in step S1220 that the terminal receives the second activation indicator after the validity timer expires, the first time alignment value is not valid. Accordingly, since no uplink sync is established, an uplink activating operation related to transmission of a signal through uplink cannot be performed while a downlink activating operation may be performed. In order to obtain uplink sync, the base station transmits to the terminal a second MAC message indicating a new second time alignment value (S1230). The second MAC message may be transmitted through a downlink of an activated secondary serving cell or primary serving cell. The second MAC message may be transmitted by a random access procedure. In particular, this may be initiated in response to a PDCCH command by the base station as shown in Table 2. The second MAC message includes, e.g., a random access response message or an MAC control element for a time advance command. In case the second MAC message is an MAC control element for a time advance command, an LCID field of an MAC subheader corresponding thereto is ‘11101’ according to Table 1. The MAC subheader, along with the MAC control element, may be transmitted to the terminal, included in the MAC message.

The base station performs uplink reception according to an uplink activating operation that is carried out by the terminal based on a uplink time adjusted by the second time alignment value (S1235).

Meanwhile, if the time alignment timer expires while the steps shown in FIG. 12 are performed, the terminal and the base station stop the steps of FIG. 12 and flush the data stored in all the HARQ buffers. The terminal informs release of a PUCCH/SRS to the RRC layer. At this time, the type-0 SRS (periodic SRS) is released, and the type-1 SRS (aperiodic SRS) is not released. The terminal initializes all configured downlink and uplink resource allocation.

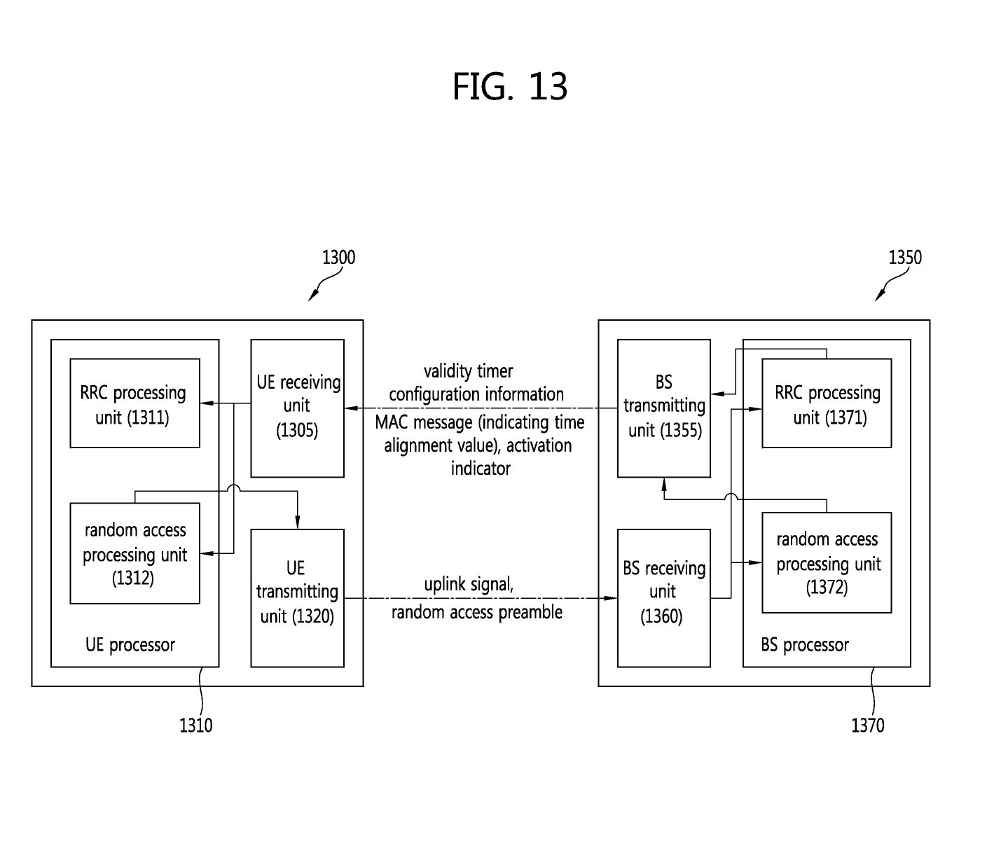

FIG. 13 is a block diagram illustrating a base station and a terminal that perform uplink sync according to an embodiment of the present invention.

Referring to FIG. 13, the terminal 1300 includes a terminal receiving unit 1305, a terminal processor 1310, and a terminal transmitting unit 1320. The terminal processor 1310 includes an RRC processing unit 1311 and a random access processing unit 1312.

The terminal receiving unit 1305 receives an RRC connection reconfiguration message, validity timer configuration information, an MAC message or an activation indicator from a base station 1350. In case the activation indicator is transmitted in the form of an MAC message, the activation indicator is referred to as an MAC message. The validity timer configuration information may be included in an upper layer's signaling, for example, an RRC message. As an example, the validity timer configuration information may be transmitted, included in an RRC connection reconfiguration message for configuring a secondary serving cell for the terminal 1300. As another example, the validity timer configuration information may be received, included in an RRC message including time alignment group configuration information used for configuring a time alignment group in the terminal 1300. The validity timer configuration information may define a time alignment value for each time alignment group that is a set of serving cells having the same time alignment value (that is, requiring the same extent of uplink time adjustment). In such case, all of the secondary serving cells in the time alignment group are influenced by the operation of one validity timer. For example, the same validity timer may apply to all of the secondary serving cells in the time alignment group, or the validity timer may apply to only the secondary serving cell that has secured configuration information on a random access channel in the time alignment group.

The RRC processing unit 1311 configures an operation of a validity timer based on the validity timer configuration information. Further, the RRC processing unit 1311 configures at least one secondary serving cell in the terminal 1300 based on the configuration is information of a serving cell included in the RRC connection reconfiguration message. The RRC processing unit 1311 further activates or deactivates the configured secondary serving cell according to what is indicated by an activation indicator.

The random access processing unit 1312 adjusts an uplink time based on a time alignment value indicated by an MAC message. Or, the random access processing unit 1312 sets a validation period Δt of a validity timer based on validity timer configuration information and controls driving, stopping and expiring a preconfigured validity timer. Meanwhile, the random access processing unit 1312 may drive the validity timer independently for each time alignment group.

The random access processing unit 1312 determines the validity of a time alignment value.

By way of example, the random access processing unit 1312, if the terminal receiving unit 1305 receives an activation indicator indicating activation of a secondary serving cell, determines that the time alignment value is not valid and discards the previous time alignment value according to the procedure as shown in FIG. 5, performing a procedure (for example, a random access procedure) for obtaining a new updated time alignment value.

As another example, the random access processing unit 1312 determines the validity of a time alignment value depending on whether the terminal receiving unit 1305 receives an activation indicator indicating activation before or after the validity timer expires according to the procedure as shown in FIG. 8. For example, the random access processing unit 1312 determines that the time alignment value is valid if the terminal receiving unit 1305 has received an activation indicator indicating activation of a secondary serving cell from the base station and the validity timer has not expired yet. Or, the random access processing unit 1312 is determines that the time alignment value is not valid if the terminal receiving unit 1305 has received an activation indicator indicating activation of a secondary serving cell from the base station and the validity timer has expired. At this time, the random access processing unit 1312 may perform only the downlink activating operation. Or, the random access processing unit 1312 does not perform any operation if the terminal receiving unit 1305 does not receive an activation indicator indicating activation of a secondary serving cell.

First, if the time alignment value is determined to be valid, the random access processing unit 1312 performs an uplink and/or downlink activating operation based on an uplink time adjusted by the valid time alignment value. For example, the downlink activating operation includes the random access processing unit 1312 initiating the operation of a deactivation timer regarding a secondary serving cell, the terminal receiving unit 1305 monitoring a PDCCH for the control region of a secondary serving cell regarding a DL SCC corresponding to the secondary serving cell, or an operation that proceeds with downlink and uplink resource allocation for a secondary serving cell. Or, the uplink activating operation includes the terminal transmitting unit 1320 performing transmission of an uplink signal. For example, the terminal transmitting unit 1320 performs transmission of a periodic SRS and an aperiodic SRS regarding a UL SCC corresponding to a secondary serving cell or reports channel quality information. Or, the uplink activating operation includes the terminal transmitting unit 1320 performing transmission or retransmission of a PUSCH.

In contrast, if the time alignment value is determined to be invalid, the random access processing unit 1312 performs only the downlink activating operation while discarding or resetting the invalid time alignment value. The terminal receiving unit 1305 receives a new MAC message indicating a newly updated time alignment value from the base station 1350. At is this time, the new MAC message is received through an activated downlink secondary serving cell or a primary serving cell. The new MAC message may be obtained by a random access procedure. In particular, this may be initiated in response to a PDCCH command by the base station as shown in Table 2. The new MAC message includes, e.g., a random access response message or an MAC control element for a time advance command. In case the new MAC message is an MAC control element for a time advance command, an LCID field of an MAC subheader corresponding thereto is ‘11101’ according to Table 1. Thereafter, the random access processing unit 1312 performs an uplink activating operation related to transmission of a signal through uplink based on a uplink time adjusted by the updated time alignment value.

As another example, the random access processing unit 1312 determines the validity of a time alignment value depending on whether the terminal receiving unit 1305 has received an activation indicator indicating activation of a secondary serving cell before or after the operation preparation time has expired according to the procedure as shown in FIG. 9. The operation preparation time is started when the deactivation timer of the secondary serving cell expires.

As another example, the random access processing unit 1312 determines a time alignment value regarding a primary serving cell as a valid time alignment value.

Here, the random access processing unit 1312 may configure the same validity timer for all of the serving cells in a time alignment group and may configure a validity timer independently for each time alignment group.

The random access processing unit 1312 processes a non-contention based or contention-based random access procedure. The random access processing unit 1312 generates a random access preamble so as to secure uplink time sync for a secondary serving cell. The is generated random access preamble may be a dedicated random access preamble that is allocated by the base station 1350. In case multiple time alignment groups are configured in the terminal 1300, the random access processing unit 1312 may generate random access preambles that are to be transmitted over an activated secondary serving cell (for example, a representative secondary serving cell) in each time alignment group.

The terminal transmitting unit 1320 transmits an uplink signal or random access-related message to the base station 1350 over an activated secondary serving cell. For example, the random access-related message includes a random access preamble.

The base station 1350 includes a base station transmitting unit 1355, a base station receiving unit 1360, and a base station processor 1370. The base station processor 1370 includes an RRC processing unit 1371 and a random access processing unit 1372.

The base station transmitting unit 1355 transmits validity timer configuration information, an MAC message, an activation indicator, or a random access-related message to the terminal 1300.

The base station receiving unit 1360 receives an uplink signal or a random access preamble from the terminal 1300 over an activated secondary serving cell.

The RRC processing unit 1371 generates an RRC-related message, for example, an RRC connection complete message or an RRC connection reconfiguration message. Further, the RRC processing unit 1371 configures a time alignment group and generates time alignment group configuration information or validity timer configuration information. In particular, the RRC processing unit 1371 may generate configuration information regarding the validity timer independently for each time alignment group or may generate configuration information regarding the validity timer equally for all the serving cells. The RRC processing is unit 1371 activates or deactivates a secondary serving cell configured in the terminal 1300 according to an activation indicator indicated by the random access processing unit 1372. For example, the RRC processing unit 1371 may activate all the serving cells in a time alignment group depending on a serving cell activated by the activation indicator in a specific sub-frame determined (or calculated) based on the sub-frame where the activation indicator is received.

The random access processing unit 1372 selects one of previously reserved dedicated random access preambles for a non-contention based random access procedure among all the available random access preambles and generates preamble allocation information including an index of the selected random access preamble and useable time/frequency resource information.

Further, the random access processing unit 1372 generates an MAC message indicating a time alignment group. The MAC message includes a time advance command field, and the time alignment value indicated by the time advance command field indicates a variation in a relative uplink time with respect to the current uplink time, which may be an integer multiple a sampling time (Ts), for example, 16Ts. The time alignment value may be represented as a specific index.

The random access processing unit 1372 determines the validity of a time alignment value. If the time alignment value is valid, the random access processing unit 1372 indicates, to the RRC processing unit 1371, an uplink and/or downlink activating operation based on an uplink time adjusted by the time alignment value. For example, the base station transmitting unit 1355 transmits a PDCCH for the control region of a secondary serving cell regarding a DL SCC corresponding to the secondary serving cell to the terminal 1300 or proceeds with downlink and uplink resource allocation for a secondary serving cell. Or, the is base station receiving unit 1360 receives an uplink signal from the terminal 1300. For example, the base station receiving unit 1360 receives a periodic SRS and an aperiodic SRS regarding a UL SCC corresponding to a secondary serving cell or receives a report of channel quality information. Or, the base station receiving unit 1360 receives a PUSCH transmitted or retransmitted from the terminal 1300.

If the time alignment value is not valid (that is, the secondary serving cell is activated right after the validity timer expires), the random access processing unit 1372 generates a new MAC message indicating a newly updated time alignment value, and the base station transmitting unit 1355 transmits the new MAC message to the terminal 1300. The second MAC message may be transmitted by a random access procedure after the secondary serving cell has been activated. In particular, this may be initialized in response to a PDCCH command by the base station as shown in Table 2.

By way of example, the random access processing unit 1372, if the terminal receiving unit 1305 receives an activation indicator indicating activation of a secondary serving cell, determines that the time alignment value is not valid and discards the previous time alignment value according to the procedure as shown in FIG. 5 while performing a procedure (for example, random access procedure) for obtaining a newly updated time alignment value.

As another example, the random access processing unit 1372 may determine the validity of a time alignment value depending on whether the terminal 1300 has received an activation indicator indicating activation of a secondary serving cell before or right after the validity timer has expired.

As still another example, the random access processing unit 1372 determines the validity of a time alignment value depending on whether the terminal 1300 has received an is activation indicator indicating activation of a secondary serving cell before or right after the operation preparation time has expired according to the procedure as shown in FIG. 9. The operation preparation time is started as the deactivation timer of the secondary serving cell expires.

As yet still another example, the random access processing unit 1372 determines a time alignment value regarding a primary serving cell as a valid time alignment value.

Although embodiments of the present invention have been described, it will be understood by those skilled in the art that various changes or modifications can be made thereto without departing from the essential features of the present invention. Accordingly, the embodiments disclosed herein should not be construed as limiting the technical spirit of the present invention and as limited thereto. The scope of the present invention should be interpreted by the following claims, and all the technical spirit in the equivalents of the present invention should be interpreted as included in the scope of the present invention.

1. A method of performing uplink synchronization by a terminal, the method comprising:
receiving a medium access control (MAC) message including a time alignment value from a base station;
adjusting a time for an uplink in at least one secondary serving cell configured in the terminal by applying the time alignment value to a time alignment group including the at least one secondary serving cell;
receiving a MAC message indicating activation of a deactivated serving cell in the time alignment group;
activating the at least one secondary serving cell according to the serving cell in a sub-frame determined based on a sub-frame where the MAC message is received; and
performing uplink transmission according to the adjusted time,
wherein the uplink transmission is performed in a case where the time alignment value is determined to be valid or in a case where the time alignment value is a time alignment value for a primary serving cell.

2. The method of claim 1, wherein in a case where the MAC message is received or the at least one secondary serving cell is activated inbetween the time when a validity timer indicating a validation period of the time alignment value starts and the time when the validity timer expires, the time alignment value is determined to be valid.

3. The method of claim 2, further comprising:
in a case where the MAC message is received after the validity timer expires or the at least one secondary serving cell is activated after the validity timer expires, discarding the time alignment value; and
performing a random access procedure for obtaining a new time alignment value for readjusting a time for the uplink.

4. The method of claim 2, wherein the validity timer is applied to all serving cells in the time alignment group.

5. The method of claim 2, wherein the validity timer is configured independently for each time alignment group.

6. A method of performing uplink synchronization by a base station, the method comprising:
transmitting a medium access control (MAC) message including a time alignment value to a terminal;
applying the time alignment value to a time alignment group including at least one secondary serving cell configured in the terminal;
transmitting a MAC message indicating activation of a deactivated serving cell in the time alignment group to the terminal;
performing activation of the at least one secondary serving cell according to the serving cell in a sub-frame determined based on a sub-frame where the MAC message has been transmitted; and
performing uplink reception according to a time adjusted by the time alignment value,
wherein the uplink reception is performed in a case where the time alignment value is determined to be valid by the terminal or in a case where the time alignment value is a time alignment value regarding a primary serving cell.

7. The method of claim 6, wherein in a case where the MAC message is transmitted or the at least one secondary serving cell is activated inbetween the time when a validity timer indicating a validation period of the time alignment value starts and the time when the validity timer expires, the time alignment value is determined to be valid.

8. The method of claim 7, further comprising:
in a case where the MAC message is transmitted after the validity timer expires or the at least one secondary serving cell is activated after the validity timer expires, discarding the time alignment value; and
performing a random access procedure for obtaining a new time alignment value for readjusting a time for the uplink.

9. The method of claim 7, wherein the validity timer is applied to all serving cells in the time alignment group.

10. The method of claim 7, wherein the validity timer is configured independently for each time alignment group.

11. A terminal to perform uplink synchronization, the terminal comprising:
a terminal receiving unit to receive a medium access control (MAC) message including a time alignment value and a MAC message indicating activation of a deactivated serving cell in a time alignment group from a base station;
a random access processing unit to adjust a time for an uplink in at least one secondary serving cell configured in the terminal by applying the time alignment value to a time alignment group including the at least one secondary serving cell;
a terminal transmitting unit to perform uplink transmission according to the adjusted time; and
a radio resource control (RRC) processing unit to perform activation of the at least one secondary serving cell according to the serving cell in a sub-frame determined based on a sub-frame where the MAC message has been received,
wherein the terminal transmitting unit performs the uplink transmission in a case where the random access processing unit determines the time alignment value as valid or in a case where the time alignment value is identified as a time alignment value regarding a primary serving cell.

12. The terminal of claim 11, wherein the random access processing unit drives a validity timer indicating a validation period of the time alignment value, and
wherein, in a case where the terminal receiving unit receives the MAC message or the at least one secondary serving cell is activated before the validity timer expires, the random access processing unit determines that the time alignment value as valid.

13. The terminal of claim 12, wherein in a case where the MAC message is received after the validity timer expires or the at least one secondary serving cell is activated after the validity timer expires, the random access processing unit discards the time alignment value and performs a random access procedure for obtaining a new time alignment value for readjusting a time for the uplink.

14. The terminal of claim 12, wherein the random access processing unit applies the validity timer to all serving cells in the time alignment group.

15. The terminal of claim 12, wherein the random access processing unit configures the validity timer independently for each time alignment group.

16. A base station to perform uplink synchronization, the base station comprising:
a base station transmitting unit to transmit a medium access control (MAC) message including a time alignment value and a MAC message indicating activation of a deactivated serving cell in a time alignment group;
a random access processing unit to apply the time alignment value to a time alignment group including at least one secondary serving cell configured in the terminal;
a radio resource control (RRC) processing unit to perform activation of the at least one secondary serving cell according to the serving cell in a sub-frame determined based on a sub-frame where the MAC message has been transmitted; and
a base station receiving unit to perform uplink reception according to a time adjusted by the time alignment value,
wherein the base station receiving unit performs the uplink reception in a case where the random access processing unit determines the time alignment value as valid or in a case where the time alignment value is identified to be a time alignment value regarding a primary serving cell.

17. The base station of claim 16, wherein in a case where the base station transmitting unit receives the MAC message or the RRC processing unit activates the at least one secondary serving cell inbetween the time a validity timer indicating a validation period of the time alignment value starts and the time when the validity timer expires, the random access processing unit determines the time alignment value as valid.

18. The base station of claim 17, wherein in a case where the base station transmitting unit transmits the MAC message after the validity timer expires or the RRC processing unit activates the at least one secondary serving cell after the validity timer expires, the random access processing unit discards the time alignment value and performs a random access procedure for obtaining a new time alignment value for readjusting a time for the uplink.

19. The base station of claim 17, wherein the random access processing unit applies the validity timer to all serving cells of the time alignment group.

20. The base station of claim 17, wherein the random access processing unit configures the validity timer independently for each time alignment group.
